(19) United States
(12) Patent Application Publication
(10) Pub. No.: US 2011/0231103 A1
(43) Pub. Date: Sep. 22, 2011

(54) METHODS FOR DETERMINING MOLECULAR PHARMACOLOGY USING LABEL-FREE INTEGRATIVE PHARMACOLOGY

(76) Inventor: Ye Fang, Painted Post, NY (US)

(21) Appl. No.: 13/048,567

(22) Filed: Mar. 15, 2011

Related U.S. Application Data
(60) Provisional application No. 61/315,625, filed on Mar. 19, 2010.

(51) Int. Cl. G06F 19/00

(52) U.S. Cl. 702/19

(57) ABSTRACT

Disclosed are methods and machines to perform cluster analysis on label free biosensor data.

### CLAIMING BENEFIT OF PRIOR FILED U.S. APPLICATION

This application claims the benefit of priority to U.S. Provisional Application No. 61/315,625, filed on Mar. 19, 2010, which is incorporated by reference here.

### BACKGROUND

Label-free biosensor cellular assays generally use a label-free biosensor to detect cellular responses in a cell in response to stimulation. The resultant biosensor signal is typically an integrated response reflecting the complexity of molecular pharmacology acting on the cell. Traditionally, a label-free biosensor cellular assay directly monitors the kinetic response of a cell upon stimulation with a molecule, leading to a primary profile of the molecule acting on the cell. Alternatively, a label-free biosensor cellular assay can also be used to examine the impact of the molecule on a marker-induced biosensor signal in a cell, leading to a secondary profile of the molecule against the marker-triggered pathway(s) in the cell. The marker is a known molecule that is able to trigger a reproducible biosensor signal in the cell.

Recently, we proposed a label-free integrative pharmacology approach to characterize molecules (see U.S. application Ser. No. 12/623,693. Fang, Y. et al. “Methods for Characterizing Molecules”, Filed Nov. 23, 2009; U.S. application Ser. No. 12/623,708. Fang, Y. et al. “Methods of creating an index”, filed Nov. 23, 2009). In this label-free integrative pharmacology approach, a label-free biosensor is used to determine the systems cell pharmacology of a drug candidate molecule by monitoring its direct actions on panels of different types of cells representative to human physiology and human pathophysiology, as well as to determine the ability of the drug candidate molecule to modulate the biosensor signals of each cell in response to stimulation, independently or collectively, with a panel of marker molecules. The direct action of a molecule on a cell leads to its primary profile in the respective cell, while the modulation of the molecule against a marker-induced biosensor signal results in a secondary profile that is relative to the marker-cell system. Both types of profiles are generally recorded as real time kinetic cellular responses. Comparing the primary profiles in the absence of a molecule with the secondary profiles in the presence of the molecule across multiple cells on which panels of markers act leads to panels of modulation profiles of the molecule against these markers. The entire or partial panels of profiles, for example, can be combined to produce an index. For example, the assembly of all primary profiles of a molecule acting on the panels of cells produces a molecule biosensor primary index, whereas the assembly of the modulation profiles of a molecule against the panels of markers acting on corresponding cells produces a molecule biosensor modulation index, and the combination of the molecule biosensor primary index with the molecule biosensor modulation index produces a molecule biosensor index. Comparing the molecule index with established indexes of panels of pharmacologically known modulators allows one to determine the cellular receptor(s) or target(s) or pathway(s) with which the molecule intervene(s).

This label-free integrative pharmacology approach not only provides information regarding the mode of actions (e.g., target(s), pathway(s), agonism or antagonism, or toxicity) of any molecule, but also enables the determination of their potency, selectivity, and systems cell pharmacology including polypharmacology and phenotypic pharmacology. Crucial to label-free integrative pharmacology is the methods to effectively determine the similarity of an unknown molecule with a known referencing molecule whose pharmacology is at least partially known, based on the molecule biosensor index, and/or the molecule biosensor primary index, and/or the molecule biosensor modulation index.

### SUMMARY

Disclosed herein are effective methods related to label-free integrative pharmacology to determine similarity between any pairs or groups of molecules. The similarity analysis can be carried out at different levels, including the molecule biosensor index, the molecule biosensor primary index, the molecule biosensor modulation index, and the molecule biosensor index in a specific cell or with a specific panel of markers. Disclosed methods enable the determination the polypharmacology, phenotypic pharmacology and functional selectivity of any molecules.

Disclosed are methods to identify molecular pharmacology using label-free integrative pharmacology. The methods are related to the use of clustering analysis to determine the similarity of an unknown molecule with a known reference molecule whose pharmacology is at least partially known, thus to determine the pharmacology of the unknown molecule. Disclosed herein are the methods of using clustering algorithm(s) to compare the similarity of a biosensor index of an unknown marker with a reference molecule. The preferable clustering algorithm(s) and methods are disclosed.

### BRIEF DESCRIPTION OF THE DRAWINGS

FIGS. 1A and B shows two different procedures of a clustering algorithm based similarity analysis to determine the pharmacology of any molecules.

FIG. 2A-2P shows representative DMR primary profiles of a set of known G protein-coupled receptor agonists in A431 cells. A431 cells were grown into a monolayer on Epic® 384well cell culture compatible microplates. After starvation for overnight, the quiescent A431 cells were stimulated with corresponding agonists, each at 10 micromolar. The real time kinetic responses were presented. Each agonist, as indicated in each graph, had been duplicated to show assay reproducibility. The numbers in each graph indicated the location of wells in the 384well microplate.

FIG. 3A to 3P shows representative DMR primary profiles of another set of known G protein-coupled receptor agonists in A431 cells. A431 cells were grown into a monolayer on Epic® 384well cell culture compatible microplates. After starvation for overnight, the quiescent A431 cells were stimulated with corresponding agonists, each at 10 micromolar. The real time kinetic responses were presented. Each agonist, as indicated in each graph, had been duplicated to show assay reproducibility. The numbers in each graph indicated the location of wells in the 384well microplate.

FIG. 4 shows a heat map showing the clusters, based on their primary DMR profiles, of panels of known GPCR agonists in A431 cells examined. For all agonists, the absolute response (in picometer related to the shift in the resonant wavelength of a biosensor having a cell layer upon stimulation) at each time point (as indicated) was used to carry out similarity analysis.

FIG. 5 shows a heat map showing the clusters, based on their primary DMR profiles, of known GPCR agonists in A431 cells examined. For all agonists, the absolute response (in picometer related to the shift in the resonant wavelength of a biosensor having a cell layer upon stimulation) at 4 predetermined time points (as indicated) was used to carry out similarity analysis.

FIG. 6 shows a heat map showing the clusters of the compounds similar to the known anti-histamine drug levocabastine, based on their modulation index against a panel of 15 markers and 4 cell lines (see details in the main text).

FIG. 7 shows a heat map (e) showing the clusters of a panel of beta2 adrenergic receptor ligands acting on quiescent A431 cells to determine the functional selectivity of these agonists. For all ligands, the four kinetic parameters, (a-d) as indicated, of the primary DMR signals of these ligands were used for clustering analysis.

### DETAILED DESCRIPTION

### A. Clustering and Clustering Algorithms

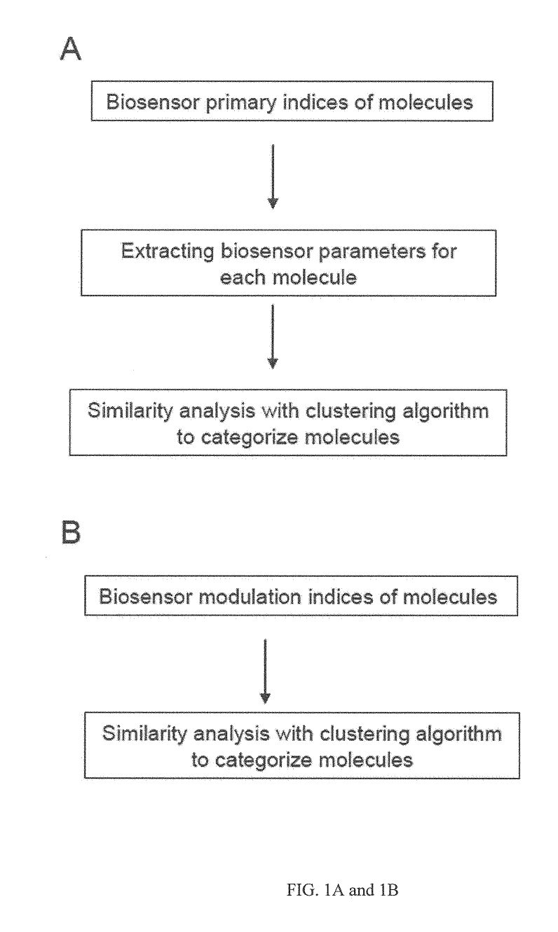

Disclosed are methods related to label-free integrative pharmacology and approaches based on one-dimensional and two-dimensional clustering algorithms to cluster molecules. As shown in FIG. 1, the disclosed methods can use two-dimensional clustering algorithms to generate molecule clusters, using label-free biosensor cellular data, for example, the molecule biosensor primary indices, or the molecule biosensor modulation indices, or both. Representative clustering algorithms include, but are not limited to, Hierarchical, K-means, FORCE, and MCL clustering.

Clustering is a widely established technique for exploratory data analysis with applications in statistics, computer science, biology, social sciences, or psychology. It is applied to empirical data in many scientific fields to gain an initial impression of structural similarities. For this purpose, it is of great advantage to have an efficient and easy-to-use tool that can be applied ubiquitously to a large scope of data types. However, the applications of clustering analysis in label-free cellular assays and label-free integrative pharmacology have not been explored, and the unique aspects of label-free biosensor cellular assays and label-free integrative pharmacology assays, as disclosed herein, have unique forms of clustering analysis as disclosed herein.

The clustering analysis is generally carried out using conventional pairwise similarity functions to determine similarity (or distance) for each unordered pair in the dataset, leading to a similarity matrix. The conventional pairwise similarity functions include, but not limited to, Hierarchical, and k-Means. Both Hierarchical and K-means have been applied to cluster expression or genetic data. Hierarchical and k-Means clusters may be displayed as hierarchical groups of nodes or as heat maps. Other known methods, such as MCL and FORCE, can also be used.

### B. Methods

The methods disclosed herein, as well as the compositions and compounds which can be used in the methods, can arise from a number of different classes, such as materials, substance, molecules, and ligands. Also disclosed is a specific subset of these classes, unique to label free biosensor assays, called markers, for example, EGF as a marker for EGFR activation.

It is understood that mixtures of these classes, such as a molecule mixture are also disclosed and can be used in the disclosed methods.

In certain methods, unknown molecules, reference molecules, test molecules, drug candidate molecules as well as known molecules can be used.

In certain methods or situations, modulating or modulators play a role. Likewise, known modulators can be used.

In certain methods, as well as compositions, cells are involved, and cells can undergo culturing and cell cultures can be used as discussed herein.

The methods disclosed herein involve assays that use biosensors. In certain assays, they are performed in either an agonism or antagonism mode. Often the assays involve treating cells with one or more classes, such as a material, a substance, or a molecule. It is also understood that subjects can be treated as well, as discuss herein.

In certain methods, contacting between a molecule, for example, and a cell can take place. In the disclosed methods, responses, such as cellular response, which can manifest as a biosensor response, such as a DMR response, can be detected. These and other responses can be assayed. In certain methods the signals from a biosensor can be robust biosensor signals or robust DMR signals.

The disclosed methods utilizing label free biosensors can produce profiles, such as primary profiles, secondary profiles, and modulation profiles. These profiles and others can be used for making determinations about molecules, for example, and can be used with any of the classes discussed herein.

Also disclosed are libraries and panels of compounds or compositions, such as molecules, cells, materials, or substances disclosed herein. Also disclosed are specific panels, such as marker panels and cell panels.

The disclosed methods can utilize a variety of aspects, such as biosensor signals, DMR signals, normalizing, controls, positive controls, modulation comparisons, Indexes, Biosensor Indexes, DMR indexes, Molecule biosensor indexes, molecule DMR indexes, molecule indexes, modulator biosensor indexes, modulator DMR indexes, molecule modulation indexes, known modulator biosensor indexes, known modulator DMR indexes, marker biosensor indexes, marker DMR indexes, modulating the biosensor signal of a marker, modulating the DMR signal, potentiating, and similarity of indexes.

Any of the compositions, compounds, or anything else disclosed herein can be characterized in any way disclosed herein.

Disclosed are methods that rely on characterizations, such as higher and inhibit and like words.

In certain methods, receptors or cellular targets are used. Certain methods can provide information about signaling pathway(s) as well as molecule-treated cells and other cellular processes.

In certain embodiments, a certain potency or efficacy becomes a characteristic, and the direct action (of a drug candidate molecule, for example) can be assayed.

### 1. Methods

Label-free biosensor cellular assays often provide an integrated readout of live cells or whole cells in a pathway-unbiased but pathway-sensitive manner. As a result, label-free biosensor cellular assays often reflect the complexity of receptor biology and drug pharmacology. Coupled with the non-specific nature of label-free biosensor as well as the complexity of cell biology (e.g., redundant signaling elements, and compensated feedback loops), a single target-based label-free biosensor cellular assay typically leads to high percentage false positives.

### 2. Specific Embodiments

Disclosed are methods of determining the similarity of a label-free biosensor data set comprising: a) obtaining a label free biosensor data set, b) performing a cluster analysis on said data set.

Also disclosed are methods, wherein the cluster analysis comprises performing a Hierarchical clustering method, wherein the Hierarchical clustering method comprises an agglomerative method, wherein the Hierarchical clustering method comprises a divisive method, comprising a measure of dissimilarity between sets of observations, wherein the measure of dissimilarity comprises a distance metric and a linkage criteria, or alone or in any combination with any step, machine, or article herein.

Disclosed are methods, wherein the distance metric comprise a Euclidean distance method, squared Euclidean distance method, City-block distance method, Manhattan distance method, Pearson corrlation method, Pearson corrlation absolute value method, Uncentered correlation method, Centered correlation method, Spearman's rank correlation method, Kendall's tau method, maximum distance method, Mahalanobis distance method, or a cosine similarity method.

Also disclosed are methods, wherein when the data set comprises data from a molecule primary indice the distance metric comprises the uncentered correlation with absolute value, wherein when the data set comprises data from a molecule modulation indice the distance metric comprises either the uncentered correlation with absolute value method or the centered correlation with absolute value method, wherein the distance metric comprises a Euclidean distance method, wherein the linkage criteria comprises a pairwise average-linkage, a pairwise single-linkage, a pairwise maximum-linkage, or a pairwise centroid-linkage, wherein the linkage criteria comprises a pairwise maximum-linkage, comprising a distance matrix, wherein the distance matrix is made up of distances between two rows in the matrix, wherein the rows represent nodes in the distance matrix, or alone or in any combination with any step, machine, or article herein.

Disclosed are methods, further comprising a predefined clustering threshold, such as density parameter or similarity threshold, or alone or in any combination with any step, machine, or article herein.

Disclosed are methods, wherein the predefined clustering threshold is a biosensor parameter, or alone or in any combination with any step, machine, or article herein.

Also disclosed are methods, wherein performing the clustering analysis produces a similarity matrix, wherein the node comprises the molecule used in the biosensor assay, wherein the edge attribute comprises a parameter of the cell response to the molecule or a parameter of a modulation indice (i.e. modulation percentage of the molecule against a marker), wherein an edge attribute is selected, wherein multiple node attributes are selected, wherein only a subset of the nodes are selected, or alone or in any combination with any step, machine, or article herein.

Disclosed are methods, further comprising a normalization or data pretreatment step, or alone or in any combination with any step, machine, or article herein.

Also disclosed are methods, wherein the data pretreatment step comprises data filtering, wherein when the data set comprises data from a primary indice the data filtering comprises a max-min difference computation, wherein the max-min difference computation selects data points that have at least a 40 picometer max-min difference within one hour post stimulation, wherein when the data set comprises data from a modulation indice the data filtering step comprises removing molecules whose biosensor modulation indice contain less than or equal to 15% modulation against all the markers or a specific set of markers, wherein the clustering analysis comprises a two-dimensional clustering analysis, wherein the clustering algorithm is first run with the nodes of the matrix producing a hierarchical clustering of the nodes given the values of the edge attributes and then with the attributes of the matrix, producing a hierarchical clustering of the attributes for a given node, wherein the clustering algorithm is first run with the edge attributes of the matrix and then with the nodes of the matrix, or alone or in any combination with any step, machine, or article herein.

Disclosed are methods, further comprising the step of producing a heat map, or alone or in any combination with any step, machine, or article herein.

Also disclosed are methods, wherein the heat map comprises a clustered map, wherein the clustered map comprises a HeatMapView, wherein the heat map comprises an Eisen TreeView or an Eisen KnnView, wherein the edge attribute comprises an absolute response of a biosensor response, predetermined kinetic parameter, or modulation percentage, wherein the method is a computer implemented method, further comprising the step of outputting results from the cluster analysis, or alone or in any combination with any step, machine, or article herein.

Disclosed are methods of analyzing a label free biosensor data set comprising; receiving a label free biosensor data set record and performing a cluster analysis, wherein the record contains biosensor data measuring a biosensor response and outputting results from the cluster analysis, or alone or in any combination with any step, machine, or article herein.

Also disclosed are methods, wherein the method is a computer implemented method, wherein receiving the label free biosensor data set record comprises receiving the label free biosensor data set record from a storage medium, wherein receiving the label free biosensor data set record comprises receiving the record from a computer system, wherein receiving the label free biosensor data set record comprises receiving the record from a biosensor system, wherein receiving the label free biosensor data set record comprises receiving the label free biosensor data set record via a computer network, or alone or in any combination with any step, machine, or article herein.

Disclosed are one or more computer readable media storing program code that, upon execution by one or more computer systems, causes the computer systems to perform the any of the methods herein, or alone or in any combination with any step, machine, or article herein.

Disclosed are computer program products comprising a computer usable memory adapted to be executed to implement any of the methods herein, or alone or in any combination with any step, machine, or article herein.

Also disclosed are computer programs, comprising a logic processing module, a configuration file processing module, a data organization module, and data display organization module, that are embodied upon a computer readable medium, or alone or in any combination with any step, machine, or article herein.

Disclosed are computer program products, comprising a computer usable medium having a computer readable program code embodied therein, said computer readable program code adapted to be executed to implement a method for generating the cluster analysis of any method disclosed herein, said method further comprising: providing a system, wherein the system comprises distinct software modules, and wherein the distinct software modules comprise a logic processing module, a configuration file processing module, a data organization module, and a data display organization module, or alone or in any combination with any step, machine, or article herein.

Also disclosed are methods, further comprising a computerized system configured for performing the method, further comprising the outputting of the results from the cluster analysis, or alone or in any combination with any step, machine, or article herein.

Disclosed are computer-readable media having stored thereon instructions that, when executed on a programmed processor perform any of the methods, or alone or in any combination with any step, machine, or article herein.

Disclosed are cluster analysis systems, the systems comprising: a data store capable of storing label free biosensor data set; a system processor comprising one or more processing elements, the one or more processing elements programmed or adapted to: receive the label free biosensor data set; store the label free biosensor data set in the data store; perform a cluster analysis on the label free biosensor data set; and output a result from the cluster analysis, or alone or in any combination with any step, machine, or article herein.

Also disclosed are systems, wherein the system receives the label free biosensor data from a biosensor system, wherein the system receives the label free biosensor data via a computer network, further comprising a biosensor system, or alone or in any combination with any step, machine, or article herein.

### C. Biosensors and Biosensor Cellular Assays

Label-free cell-based assays generally employ a biosensor to monitor molecule-induced responses in living cells. The molecule can be naturally occurring or synthetic, and can be a purified or unpurified mixture. A biosensor typically utilizes a transducer such as an optical, electrical, calorimetric, acoustic, magnetic, or like transducer, to convert a molecular recognition event or a molecule-induced change in cells contacted with the biosensor into a quantifiable signal. These label-free biosensors can be used for molecular interaction analysis, which involves characterizing how molecular complexes form and disassociate over time, or for cellular response, which involves characterizing how cells respond to stimulation. The biosensors that are applicable to the present methods can include, for example, optical biosensor systems such as surface plasmon resonance (SPR) and resonant waveguide grating (RWG) biosensors, resonant mirrors, ellipsometers, and electric biosensor systems such as bioimpedance systems.

1. Acoustic Biosensors

Acoustic biosensors such as quartz crystal resonators utilize acoustic waves to characterize cellular responses. The acoustic waves are generally generated and received using piezoelectric. An acoustic biosensor is often designed to operate in a resonant type sensor configuration. In a typical setup, thin quartz discs are sandwiched between two gold electrodes. Application of an AC signal across electrodes leads to the excitation and oscillation of the crystal, which acts as a sensitive oscillator circuit. The output sensor signals are the resonance frequency and motional resistance. The resonance frequency is largely a linear function of total mass of adsorbed materials when the biosensor surface is rigid. Under liquid environments the acoustic sensor response is sensitive not only to the mass of bound molecules, but also to changes in viscoelastic properties and charge of the molecular complexes formed or live cells. By measuring the resonance frequency and the motion resistance of cells associated with the crystals, cellular processes including cell adhesion and cytotoxicity can be studied in real time.

2. Electrical Biosensors

Electrical biosensors employ impedance to characterize cellular responses including cell adhesion. In a typical setup, live cells are brought in contact with a biosensor surface wherein an integrated electrode array is embedded. A small AC pulse at a constant voltage and high frequency is used to generate an electric field between the electrodes, which are impeded by the presence of cells. The electric pulses are generated onsite using the integrated electric circuit; and the electrical current through the circuit is followed with time. The resultant impedance is a measure of changes in the electrical conductivity of the cell layer. The cellular plasma membrane acts as an insulating agent forcing the current to flow between or beneath the cells, leading to quite robust changes in impedance. Impedance-based measurements have been applied to study a wide range of cellular events, including cell adhesion and spreading, cell micromotion, cell morphological changes, and cell death, and cell signaling.

3. Optical Biosensors

Optical biosensors primarily employ a surface-bound electromagnetic wave to characterize cellular responses. The surface-bound waves can be achieved either on gold substrates using either light excited surface plasmons (surface plasmon resonance, SPR) or on dielectric substrate using diffraction grating coupled waveguide mode resonances (resonance waveguide grating, RWG). For SPR including mid-IR SPR, the readout is the resonance angle at which a minimal in intensity of reflected light occurs. Similarly, for RWG biosensor including photonic crystal biosensors, the readout is the resonance angle or wavelength at which a maximum incoupling efficiency is achieved. The resonance angle or wavelength is a function of the local refractive index at or near the sensor surface. Unlike SPR which is limited to a few of flow channels for assaying, RWG biosensors are amenable for high throughput screening (HTS) and cellular assays, due to recent advancements in instrumentation and assays. In a typical RWG, the cells are directly placed into a well of a microtiter plate in which a biosensor consisting of a material with high refractive index is embedded. Local changes in the refractive index lead to a dynamic mass redistribution (DMR) signal of live cells upon stimulation. These biosensors have been used to study diverse cellular processes including receptor biology, ligand pharmacology, and cell adhesion.

The present invention preferably uses resonant waveguide grating biosensors, such as Corning Epic® systems. Epic® system includes the commercially available wavelength integration system, or angular interrogation system or swept wavelength imaging system (Corning Inc., Corning, N.Y.). The commercial system consists of a temperature-control unit, an optical detection unit, with an on-board liquid handling unit with robotics, or an external liquid accessory system with robotics. The detection unit is centered on integrated fiber optics, and enables kinetic measures of cellular responses with a time interval of ˜7 or 15 sec. The compound solutions were introduced by using either the on-board liquid handling unit, or the external liquid accessory system; both of which use conventional liquid handling systems. Different RWG biosensor systems including high resolution imaging systems as well as high acquisition optical biosensor systems can also be used.

4. SPR Biosensors and Systems

SPR relies on a prism to direct a wedge of polarized light, covering a range of incident angles, into a planar glass substrate bearing an electrically conducting metallic film (e.g., gold) to excite surface plasmons. The resultant evanescent wave interacts with, and is absorbed by, free electron clouds in the gold layer, generating electron charge density waves (i.e., surface plasmons) and causing a reduction in the intensity of the reflected light. The resonance angle at which this intensity minimum occurs is a function of the refractive index of the solution close to the gold layer on the opposing face of the sensor surface

5. RWG Biosensors and Systems

An RWG biosensor can include, for example, a substrate (e.g., glass), a waveguide thin film with an embedded grating or periodic structure, and a cell layer. The RWG biosensor utilizes the resonant coupling of light into a waveguide by means of a diffraction grating, leading to total internal reflection at the solution-surface interface, which in turn creates an electromagnetic field at the interface. This electromagnetic field is evanescent in nature, meaning that it decays exponentially from the sensor surface; the distance at which it decays to 1/e of its initial value is known as the penetration depth and is a function of the design of a particular RWG biosensor, but is typically on the order of about 200 nm. This type of biosensor exploits such evanescent wave to characterize ligand-induced alterations of a cell layer at or near the sensor surface.

RWG instruments can be subdivided into systems based on angle-shift or wavelength-shift measurements. In a wavelength-shift measurement, polarized light covering a range of incident wavelengths with a constant angle is used to illuminate the waveguide; light at specific wavelengths is coupled into and propagates along the waveguide. Alternatively, in angle-shift instruments, the sensor is illuminated with monochromatic light and the angle at which the light is resonantly coupled is measured.

The resonance conditions are influenced by the cell layer (e.g., cell confluency, adhesion and status), which is in direct contact with the surface of the biosensor. When a ligand or an analyte interacts with a cellular target (e.g., a GPCR, an ion channel, a kinase) in living cells, any change in local refractive index within the cell layer can be detected as a shift in resonant angle (or wavelength).

The Corning® Epic® system uses RWG biosensors for label-free biochemical or cell-based assays (Corning Inc., Corning, N.Y.). The Epic® System consists of an RWG plate reader and SBS (Society for Biomolecular Screening) standard microtiter plates. The detector system in the plate reader exploits integrated fiber optics to measure the shift in wavelength of the incident light, as a result of ligand-induced changes in the cells. A series of illumination-detection heads are arranged in a linear fashion, so that reflection spectra are collected simultaneously from each well within a column of a 384-well microplate. The whole plate is scanned so that each sensor can be addressed multiple times, and each column is addressed in sequence. The wavelengths of the incident light are collected and used for analysis. A temperature-controlling unit can be included in the instrument to minimize spurious shifts in the incident wavelength due to the temperature fluctuations. The measured response represents an averaged response of a population of cells. Varying features of the systems can be automated, such as sample loading, and can be multiplexed, such as with a 96 or 386 well microtiter plate. Liquid handling is carried out by either on-board liquid handler, or an external liquid handling accessory. Specifically, molecule solutions are directly added or pipetted into the wells of a cell assay plate having cells cultured in the bottom of each well. The cell assay plate contains certain volume of assay buffer solution covering the cells. A simple mixing step by pipetting up and down certain times can also be incorporated into the molecule addition step.

6. Electrical Biosensors and Systems

Electrical biosensors consist of a substrate (e.g., plastic), an electrode, and a cell layer. In this electrical detection method, cells are cultured on small gold electrodes arrayed onto a substrate, and the system's electrical impedance is followed with time. The impedance is a measure of changes in the electrical conductivity of the cell layer. Typically, a small constant voltage at a fixed frequency or varied frequencies is applied to the electrode or electrode array, and the electrical current through the circuit is monitored over time. The ligand-induced change in electrical current provides a measure of cell response. Impedance measurement for whole cell sensing was first realized in 1984. Since then, impedance-based measurements have been applied to study a wide range of cellular events, including cell adhesion and spreading, cell micromotion, cell morphological changes, and cell death. Classical impedance systems suffer from high assay variability due to use of a small detection electrode and a large reference electrode. To overcome this variability, the latest generation of systems, such as the CellKey system (MDS Sciex, South San Francisco, Calif.) and RT-CES (ACEA Biosciences Inc., San Diego, Calif.), utilize an integrated circuit having a microelectrode array.

7. High Spatial Resolution Biosensor Imaging Systems

Optical biosensor imaging systems, including SPR imaging systems, ellipsometry imaging systems, and RWG imaging systems, offer high spatial resolution, and can be used in embodiments of the disclosure. For example, SPR imager®II (GWC Technologies Inc) uses prism-coupled SPR, and takes SPR measurements at a fixed angle of incidence, and collects the reflected light with a CCD camera. Changes on the surface are recorded as reflectivity changes. Thus, SPR imaging collects measurements for all elements of an array simultaneously.

A swept wavelength optical interrogation system based on RWG biosensor for imaging-based application can be employed. In this system, a fast tunable laser source or alternative light source(s) is used to illuminate a sensor or an array of RWG biosensors in a microplate format. The sensor spectrum can be constructed by detecting the optical power reflected from the sensor as a function of time as the laser wavelength scans, and analysis of the measured data with computerized resonant wavelength interrogation modeling results in the construction of spatially resolved images of biosensors having immobilized receptors or a cell layer. The use of an image sensor naturally leads to an imaging based interrogation scheme. 2 dimensional label-free images can be obtained without moving parts.

Alternatively, angular interrogation system with transverse magnetic or p-polarized TM₀ mode can also be used. This system consists of a launch system for generating an array of light beams such that each illuminates a RWG sensor with a dimension of approximately 200 μm×3000 μm or 200 μm×2000 μm, and a CCD camera-based receive system for recording changes in the angles of the light beams reflected from these sensors. The arrayed light beams are obtained by means of a beam splitter in combination with diffractive optical lenses. This system allows up to 49 sensors (in a 7×7 well sensor array) to be simultaneously sampled at every 3 seconds, or up to the whole 384well microplate to be simultaneously sampled at every 10 seconds.

Alternatively, a scanning wavelength interrogation system can also be used. In this system, a polarized light covering a range of incident wavelengths with a constant angle is used to illuminate and scan across a waveguide grating biosensor, and the reflected light at each location can be recorded simultaneously. Through scanning, a high resolution image across a biosensor can also be achieved

8. Dynamic Mass Redistribution (DMR) Signals in Living Cells

The cellular response to stimulation through a cellular target can be encoded by the spatial and temporal dynamics of downstream signaling networks. For this reason, monitoring the integration of cell signaling in real time can provide physiologically relevant information that is useful in understanding cell biology and physiology.

Optical biosensors including resonant waveguide grating (RWG) biosensors, can detect an integrated cellular response related to dynamic redistribution of cellular matters, thus providing a non-invasive means for studying cell signaling. All optical biosensors are common in that they can measure changes in local refractive index at or very near the sensor surface. In principle, almost all optical biosensors are applicable for cell sensing, as they can employ an evanescent wave to characterize ligand-induced change in cells. The evanescent-wave is an electromagnetic field, created by the total internal reflection of light at a solution-surface interface, which typically extends a short distance (hundreds of nanometers) into the solution at a characteristic depth known as the penetration depth or sensing volume.

Recently, theoretical and mathematical models have been developed that describe the parameters and nature of optical signals measured in living cells in response to stimulation with ligands. These models, based on a 3-layer waveguide system in combination with known cellular biophysics, link the ligand-induced optical signals to specific cellular processes mediated through a receptor.

Because biosensors measure the average response of the cells located at the area illuminated by the incident light, a highly confluent layer of cells can be used to achieve optimal assay results. For high resolution label-free imaging systems, low confluent cells can be used. Alternatively, suspension cells of variable density can also be used. Due to the large dimension of the cells as compared to the short penetration depth of a biosensor, the sensor configuration is considered as a non-conventional three-layer system: a substrate, a waveguide film with a grating structure, and a cell layer. Thus, a ligand-induced change in effective refractive index (i.e., the detected signal) can be, to first order, directly proportional to the change in refractive index of the bottom portion of the cell layer:

ΔN=S(C)Δn_{c}

where S(C) is the sensitivity to the cell layer, and Δn_{c} the ligand-induced change in local refractive index of the cell layer sensed by the biosensor. Because the refractive index of a given volume within a cell is largely determined by the concentrations of bio-molecules such as proteins, Δn_{c} can be assumed to be directly proportional to ligand-induced change in local concentrations of cellular targets or molecular assemblies within the sensing volume. Considering the exponentially decaying nature of the evanescent wave extending away from the sensor surface, the ligand-induced optical signal is governed by:

$$Δ N = S ( C ) α d {\sum }_{i} Δ {C}_{i} [ {e}^{\frac{- {z}_{i}}{Δ {Z}_{C}}} - {e}^{\frac{- {z}_{i + 1}}{Δ {Z}_{C}}} ]$$

where ΔZ_{c} is the penetration depth into the cell layer, α the specific refraction increment (about 0.18/mL/g for proteins), zᵢ the distance where the mass redistribution occurs, and d an imaginary thickness of a slice within the cell layer. Here the cell layer is divided into an equal-spaced slice in the vertical direction. The equation above indicates that the ligand-induced optical signal is a sum of mass redistribution occurring at distinct distances away from the sensor surface, each with an unequal contribution to the overall response. Furthermore, the detected signal, in terms of wavelength or angular shifts, is primarily sensitive to mass redistribution occurring perpendicular to the sensor surface. Because of its dynamic nature, it also is referred to as dynamic mass redistribution (DMR) signal.

9. Cells and Biosensors

Cells rely on multiple cellular pathways or machineries to process, encode and integrate the information they receive. Unlike the affinity analysis with optical biosensors that specifically measures the binding of analytes to a protein target, living cells are much more complex and dynamic.

To study cell signaling, cells can be brought in contact with the surface of a biosensor, which can be achieved through cell culture. These cultured cells can be attached onto the biosensor surface through three types of contacts: focal contacts, close contacts and extracellular matrix contacts, each with its own characteristic separation distance from the surface. As a result, the basal cell membranes are generally located away from the surface by ˜10-100 nm. For suspension cells, the cells can be brought in contact with the biosensor surface through either covalent coupling of cell surface receptors, or specific binding of cell surface receptors, or simply settlement by gravity force. For this reason, biosensors are able to sense the bottom portion of cells.

Cells, in many cases, exhibit surface-dependent adhesion and proliferation. In order to achieve robust cell assays, the biosensor surface can require a coating to enhance cell adhesion and proliferation. However, the surface properties can have a direct impact on cell biology. For example, surface-bound ligands can influence the response of cells, as can the mechanical compliance of a substrate material, which dictates how it will deform under forces applied by the cell. Due to differing culture conditions (time, serum concentration, confluency, etc.), the cellular status obtained can be distinct from one surface to another, and from one condition to another. Thus, special efforts to control cellular status can be necessary in order to develop biosensor-based cell assays.

Cells are dynamic objects with relatively large dimensions—typically in the range of tens of microns. Even without stimulation, cells constantly undergo micromotion—a dynamic movement and remodeling of cellular structure, as observed in tissue culture by time lapse microscopy at the sub-cellular resolution, as well as by bio-impedance measurements at the nanometer level.

Under un-stimulated conditions cells generally produce an almost net-zero DMR response as examined with a RWG biosensor. This is partly because of the low spatial resolution of optical biosensors, as determined by the large size of the laser spot and the long propagation length of the coupled light. The size of the laser spot determines the size of the area studied—and usually only one analysis point can be tracked at a time. Thus, the biosensor typically measures an averaged response of a large population of cells located at the light incident area. Although cells undergo micromotion at the single cell level, the large populations of cells give rise to an average net-zero DMR response. Furthermore, intracellular macromolecules are highly organized and spatially restricted to appropriate sites in mammalian cells. The tightly controlled localization of proteins on and within cells determines specific cell functions and responses because the localization allows cells to regulate the specificity and efficiency of proteins interacting with their proper partners and to spatially separate protein activation and deactivation mechanisms. Because of this control, under un-stimulated conditions, the local mass density of cells within the sensing volume can reach an equilibrium state, thus leading to a net-zero optical response. In order to achieve a consistent optical response, the cells examined can be cultured under conventional culture conditions for a period of time such that most of the cells have just completed a single cycle of division.

Living cells have exquisite abilities to sense and respond to exogenous signals. Cell signaling was previously thought to function via linear routes where an environmental cue would trigger a linear chain of reactions resulting in a single well-defined response. However, research has shown that cellular responses to external stimuli are much more complicated. It has become apparent that the information that cells receive can be processed and encoded into complex temporal and spatial patterns of phosphorylation and topological relocation of signaling proteins. The spatial and temporal targeting of proteins to appropriate sites can be crucial to regulating the specificity and efficiency of protein-protein interactions, thus dictating the timing and intensity of cell signaling and responses. Pivotal cellular decisions, such as cytoskeletal reorganization, cell cycle checkpoints and apoptosis, depend on the precise temporal control and relative spatial distribution of activated signal-transducers. Thus, cell signaling mediated through a cellular target such as G protein-coupled receptor (GPCR) typically proceeds in an orderly and regulated manner, and consists of a series of spatial and temporal events, many of which lead to changes in local mass density or redistribution in local cellular matters of cells. These changes or redistribution, when occurring within the sensing volume, can be followed directly in real time using optical biosensors

10. DMR Signal is a Physiological Response of Living Cells

Through comparison with conventional pharmacological approaches for studying receptor biology, it has been shown that when a ligand is specific to a receptor expressed in a cell system, the ligand-induced DMR signal is receptor-specific, dose-dependent and saturate-able. For a great number of G protein-coupled receptor (GPCR) ligands, the efficacies (measured by EC₅₀ values) are found to be almost identical to those measured using conventional methods. In addition, the DMR signals exhibit expected desensitization patterns, as desensitization and re-sensitization is common to all GPCRs. Furthermore, the DMR signal also maintains the fidelity of GPCR ligands, similar to those obtained using conventional technologies. In addition, the biosensor can distinguish full agonists, partial agonists, inverse agonists, antagonists, and allosteric modulators. Taken together, these findings indicate that the DMR is capable of monitoring physiological responses of living cells.

11. DMR Signals Contain Systems Cell Biology Information of Ligand-Receptor Pairs in Living Cells

The stimulation of cells with a ligand leads to a series of spatial and temporal events, non-limiting examples of which include ligand binding, receptor activation, protein recruitment, receptor internalization and recycling, second messenger alternation, cytoskeletal remodeling, gene expression, and cell adhesion changes. Because each cellular event has its own characteristics (e.g., kinetics, duration, amplitude, mass movement), and the biosensor is primarily sensitive to cellular events that involve mass redistribution within the sensing volume, these cellular events can contribute differently to the overall DMR signal. Chemical biology, cell biology and biophysical approaches can be used to elucidate the cellular mechanisms for a ligand-induced DMR signal. Recently, chemical biology, which directly uses chemicals for intervention in a specific cell signaling component, has been used to address biological questions. This is possible due to the identification of a great number of modulators that specifically control the activities of many different types of cellular targets. This approach has been adopted to map the signaling and its network interactions mediated through a receptor, including epidermal growth factor (EGF) receptor, and G_{q}- and Gₛ-coupled receptors.

EGFR belongs to the family of receptor tyrosine kinases. EGF binds to and stimulates the intrinsic protein-tyrosine kinase activity of EGFR, initiating a signal transduction cascade, principally involving the MAPK, Akt and JNK pathways. Upon EGF stimulation, there are many events leading to mass redistribution in A431 cells—a cell line endogenously over-expressing EGFRs. It is known that EGFR signaling depends on cellular status. As a result, the EGF-induced DMR signals are also dependent on the cellular status. In quiescent cells obtained through 20 hr culturing in 0.1% fetal bovine serum, EGF stimulation leads to a DMR signal with three distinct and sequential phases: (i) a positive phase with increased signal (P-DMR), (ii) a transition phase, and (iii) a decay phase (N-DMR). Chemical biology and cell biology studies show that the EGF-induced DMR signal is primarily linked to the Ras/MAPK pathway, which proceeds through MEK and leads to cell detachment. Two lines of evidence indicate that the P-DMR is mainly due to the recruitment of intracellular targets to the activated receptors at the cell surface. First, blockage of either dynamin or clathrin activity has little effect on the amplitude of the P-DMR event. Dynamin and clathrin, two downstream components of EGFR activation, play crucial roles in executing EGFR internalization and signaling. Second, the blockage of MEK activity partially attenuates the P-DMR event. MEK is an important component in the MAPK pathway, which first translocates from the cytoplasm to the cell membrane, followed by internalization with the receptors, after EGF stimulation.

On the other hand, the EGF N-DMR event is due to cell detachment and receptor internalization. Fluorescent images show that EGF stimulation leads to a significant number of receptors internalized and cell detachment. It is known that blockage of either receptor internalization or MEK activity prevents cell detachment, and receptor internalization requires both dynamin and clathrin. This indicates that blockage of either dynamin or clathrin activity should inhibit both receptor internalization and cell detachment, while blockage of MEK activity should only inhibit cell detachment, but not receptor internalization. As expected, either dynamin or clathrin inhibitors completely inhibit the EGF-induced N-DMR (˜100%), while MEK inhibitors only partially attenuate the N-DMR (˜80%). Fluorescent images also confirm that blocking the activity of dynamin, but not MEK, impairs the receptor internalization

12. DMR Signals Contain Systems Cell Pharmacology Information of a Ligand Acting on Living Cells

Since the DMR signal is an integrated cellular response consisting of contributions of many cellular events involving dynamic redistribution of cellular matters within the bottom portion of cells, a ligand-induced biosensor signal, such as a DMR signal contains systems cell pharmacology information. It is known that GPCRs often display rich behaviors in cells, and that many ligands can induce operative bias to favor specific portions of the cell machinery and exhibit pathway-biased efficacies. Thus, it is highly possibly that a ligand can have multiple efficacies, depending on how cellular events downstream of the receptor are measured and used as readout(s) for the ligand pharmacology. It is difficult in practice for conventional cell assays, which are mostly pathway-biased and assay only a single signaling event, to systematically represent the signaling potentials of GPCR ligands. However, because label-free biosensors cellular assays do not require prior knowledge of cell signaling, and are pathway-unbiased and pathway-sensitive, these biosensor cellular assays are amenable to studying ligand-selective signaling as well as systems cell pharmacology of any ligands.

13. Biosensor Parameters

A label-free biosensor such as RWG biosensor or bioimpedance biosensor is able to follow in real time ligand-induced cellular response, resulting in a kinetic response of live cells or whole cells upon simulation. The non-invasive and manipulation-free biosensor cellular assays do not require prior knowledge of cell signaling. The resultant biosensor signal contains high information relating to receptor signaling and ligand pharmacology. Multi-parameters can be extracted from the kinetic biosensor response of cells upon stimulation. These parameters include, but not limited to, the overall dynamics, phases, signal amplitudes, as well as kinetic parameters including the transition time from one phase to another, and the kinetics of each phase (see Fang, Y., and Ferrie, A. M. (2008) “label-free optical biosensor for ligand-directed functional selectivity acting on β2 adrenoceptor in living cells”. FEBS Lett. 582, 558-564; Fang, Y., et al., (2005) “Characteristics of dynamic mass redistribution of EGF receptor signaling in living cells measured with label free optical biosensors”. Anal. Chem., 77, 5720-5725; Fang, Y., et al., (2006) “Resonant waveguide grating biosensor for living cell sensing”. Biophys. J., 91, 1925-1940).

For clustering or similarity analysis, the edge attributes (i.e., biosensor cellular response data) for each node (i.e., a molecule) can be different. For example, for a molecule profile (primary secondary) in a cell, an edge attribute can be a specific kinetic parameter (e.g., the amplitude or kinetics of a DMR event in a DMR signal), or a real value of a biosensor signal at a given time post simulation, or real values of a biosensor signal at multiple or all time points post stimulation. For a molecule biosensor secondary profile an edge attribute can also be a modulation percentage of a biosensor signal output parameter against a specific marker after normalized to the respective marker primary profile. As a result, the collective edge attribute represents an effective means to display the label-free pharmacology of a node molecule, such that the similarity of the molecule to a known molecule can be compared and determined based on the disclosed methods.

### D. Definitions

Various embodiments of the disclosure will be described in detail with reference to drawings, if any. Reference to various embodiments does not limit the scope of the disclosure, which is limited only by the scope of the claims attached hereto. Additionally, any examples set forth in this specification are not intended to be limiting and merely set forth some of the many possible embodiments for the claimed invention.

1. A

As used in the specification and the appended claims, the singular forms “a,” “an” and “the” or like terms include plural referents unless the context clearly dictates otherwise. Thus, for example, reference to “a pharmaceutical carrier” includes mixtures of two or more such carriers, and the like.

2. Abbreviations

Abbreviations, which are well known to one of ordinary skill in the art, may be used (e.g., “h” or “hr” for hour or hours, “g” or “gm” for gram(s), “mL” for milliliters, and “rt” for room temperature, “nm” for nanometers, “M” for molar, and like abbreviations).

3. About

About modifying, for example, the quantity of an ingredient in a composition, concentrations, volumes, process temperature, process time, yields, flow rates, pressures, and like values, and ranges thereof, employed in describing the embodiments of the disclosure, refers to variation in the numerical quantity that can occur, for example, through typical measuring and handling procedures used for making compounds, compositions, concentrates or use formulations; through inadvertent error in these procedures; through differences in the manufacture, source, or purity of starting materials or ingredients used to carry out the methods; and like considerations. The term “about” also encompasses amounts that differ due to aging of a composition or formulation with a particular initial concentration or mixture, and amounts that differ due to mixing or processing a composition or formulation with a particular initial concentration or mixture. Whether modified by the term “about” the claims appended hereto include equivalents to these quantities.

4. Assaying

Assaying, assay, or like terms refers to an analysis to determine a characteristic of a substance, such as a molecule or a cell, such as for example, the presence, absence, quantity, extent, kinetics, dynamics, or type of an a cell's optical or bioimpedance response upon stimulation with one or more exogenous stimuli, such as a ligand or marker. Producing a biosensor signal of a cell's response to a stimulus can be an assay.

5. Assaying the Response

“Assaying the response” or like terms means using a means to characterize the response. For example, if a molecule is brought into contact with a cell, a biosensor can be used to assay the response of the cell upon exposure to the molecule.

6. Agonism and Antagonism Mode

The agonism mode or like terms is the assay wherein the cells are exposed to a molecule to determine the ability of the molecule to trigger biosensor signals such as DMR signals, while the antagonism mode is the assay wherein the cells are exposed to a marker in the presence of a molecule to determine the ability of the molecule to modulate the biosensor signal of cells responding to the marker.

7. Biosensor

Biosensor or like terms refer to a device for the detection of an analyte that combines a biological component with a physicochemical detector component. The biosensor typically consists of three parts: a biological component or element (such as tissue, microorganism, pathogen, cells, or combinations thereof), a detector element (works in a physicochemical way such as optical, piezoelectric, electrochemical, thermometric, or magnetic), and a transducer associated with both components. The biological component or element can be, for example, a living cell, a pathogen, or combinations thereof. In embodiments, an optical biosensor can comprise an optical transducer for converting a molecular recognition or molecular stimulation event in a living cell, a pathogen, or combinations thereof into a quantifiable signal.

8. Biosensor Response

A “biosensor response”, “biosensor output signal”, “biosensor signal” or like terms is any reaction of a sensor system having a cell to a cellular response. A biosensor converts a cellular response to a quantifiable sensor response. A biosensor response is an optical response upon stimulation as measured by an optical biosensor such as RWG or SPR or it is a bioimpedence response of the cells upon stimulation as measured by an electric biosensor. Since a biosensor response is directly associated with the cellular response upon stimulation, the biosensor response and the cellular response can be used interchangeably, in embodiments of disclosure.

9. Biosensor Signal

A “biosensor signal” or like terms refers to the signal of cells measured with a biosensor that is produced by the response of a cell upon stimulation.

10. Cell

Cell or like term refers to a small usually microscopic mass of protoplasm bounded externally by a semipermeable membrane, optionally including one or more nuclei and various other organelles, capable alone or interacting with other like masses of performing all the fundamental functions of life, and forming the smallest structural unit of living matter capable of functioning independently including synthetic cell constructs, cell model systems, and like artificial cellular systems.

A cell can include different cell types, such as a cell associated with a specific disease, a type of cell from a specific origin, a type of cell associated with a specific target, or a type of cell associated with a specific physiological function. A cell can also be a native cell, an engineered cell, a transformed cell, an immortalized cell, a primary cell, an embryonic stem cell, an adult stem cell, an induced pluripotent stem, a cancer stem cell, or a stem cell derived cell. A cell system containing at least two types of cells can also be used. The cell system can be formed naturally or via co-culturing.

Human consists of about 210 known distinct cell types. The numbers of types of cells can almost unlimited, considering how the cells are prepared (e.g., engineered, transformed, immortalized, or freshly isolated from a human body) and where the cells are obtained (e.g., human bodies of different ages or different disease stages, etc).

11. Cell Culture

“Cell culture” or “cell culturing” refers to the process by which either prokaryotic or eukaryotic cells are grown under controlled conditions. “Cell culture” not only refers to the culturing of cells derived from multicellular eukaryotes, especially animal cells, but also the culturing of complex tissues and organs.

12. Cell Panel

A “cell panel” or like terms is a panel which comprises at least two types of cells. The cells can be of any type or combination disclosed herein.

13. Cellular Response

A “cellular response” or like terms is any reaction by the cell to a stimulation.

14. Cellular Process

A cellular process or like terms is a process that takes place in or by a cell. Examples of cellular process include, but not limited to, proliferation, apoptosis, necrosis, differentiation, cell signal transduction, polarity change, migration, or transformation.

15. Cellular Target

A “cellular target” or like terms is a biopolymer such as a protein or nucleic acid whose activity can be modified by an external stimulus. Cellular targets commonly are proteins such as enzymes, kinases, ion channels, and receptors.

16. Cluster

A cluster as used herein is a means of using variables to divide cases into groups or sets which are related.

17. Computer Related Terms

A computer is a programmable machine that receives input, stores and manipulates data, and provides output in a useful format.

18. Characterizing

Characterizing or like terms refers to gathering information about any property of a substance, such as a ligand, molecule, marker, or cell, such as obtaining a profile for the ligand, molecule, marker, or cell.

19. Comprise

Throughout the description and claims of this specification, the word “comprise” and variations of the word, such as “comprising” and “comprises,” means “including but not limited to,” and is not intended to exclude, for example, other additives, components, integers or steps.

20. Consisting Essentially of

“Consisting essentially of” in embodiments refers, for example, to a surface composition, a method of making or using a surface composition, formulation, or composition on the surface of the biosensor, and articles, devices, or apparatus of the disclosure, and can include the components or steps listed in the claim, plus other components or steps that do not materially affect the basic and novel properties of the compositions, articles, apparatus, and methods of making and use of the disclosure, such as particular reactants, particular additives or ingredients, a particular agents, a particular cell or cell line, a particular surface modifier or condition, a particular ligand candidate, or like structure, material, or process variable selected. Items that may materially affect the basic properties of the components or steps of the disclosure or may impart undesirable characteristics to the present disclosure include, for example, decreased affinity of the cell for the biosensor surface, aberrant affinity of a stimulus for a cell surface receptor or for an intracellular receptor, anomalous or contrary cell activity in response to a ligand candidate or like stimulus, and like characteristics.

21. Components

Disclosed are the components to be used to prepare the disclosed compositions as well as the compositions themselves to be used within the methods disclosed herein. These and other materials are disclosed herein, and it is understood that when combinations, subsets, interactions, groups, etc. of these materials are disclosed that while specific reference of each various individual and collective combinations and permutation of these molecules may not be explicitly disclosed, each is specifically contemplated and described herein. Thus, if a class of molecules A, B, and C are disclosed as well as a class of molecules D, E, and F and an example of a combination molecule, A-D is disclosed, then even if each is not individually recited each is individually and collectively contemplated meaning combinations, A-E, A-F, B-D, B-E, B-F, C-D, C-E, and C—F are considered disclosed. Likewise, any subset or combination of these is also disclosed. Thus, for example, the sub-group of A-E, B-F, and C-E would be considered disclosed. This concept applies to all aspects of this application including, but not limited to, steps in methods of making and using the disclosed compositions. Thus, if there are a variety of additional steps that can be performed it is understood that each of these additional steps can be performed with any specific embodiment or combination of embodiments of the disclosed methods.

22. Contacting

Contacting or like terms means bringing into proximity such that a molecular interaction can take place, if a molecular interaction is possible between at least two things, such as molecules, cells, markers, at least a compound or composition, or at least two compositions, or any of these with an article(s) or with a machine. For example, contacting refers to bringing at least two compositions, molecules, articles, or things into contact, i.e. such that they are in proximity to mix or touch. For example, having a solution of composition A and cultured cell B and pouring solution of composition A over cultured cell B would be bringing solution of composition A in contact with cell culture B. Contacting a cell with a ligand would be bringing a ligand to the cell to ensure the cell have access to the ligand.

It is understood that anything disclosed herein can be brought into contact with anything else. For example, a cell can be brought into contact with a marker or a molecule, a biosensor, and so forth.

23. Compounds and Compositions

Compounds and compositions have their standard meaning in the art. It is understood that wherever, a particular designation, such as a molecule, substance, marker, cell, or reagent compositions comprising, consisting of, and consisting essentially of these designations are disclosed. Thus, where the particular designation marker is used, it is understood that also disclosed would be compositions comprising that marker, consisting of that marker, or consisting essentially of that marker. Where appropriate wherever a particular designation is made, it is understood that the compound of that designation is also disclosed. For example, if particular biological material, such as EGF, is disclosed EGF in its compound form is also disclosed.

24. Control

The terms control or “control levels” or “control cells” or like terms are defined as the standard by which a change is measured, for example, the controls are not subjected to the experiment, but are instead subjected to a defined set of parameters, or the controls are based on pre- or post-treatment levels. They can either be run in parallel with or before or after a test run, or they can be a pre-determined standard. For example, a control can refer to the results from an experiment in which the subjects or objects or reagents etc are treated as in a parallel experiment except for omission of the procedure or agent or variable etc under test and which is used as a standard of comparison in judging experimental effects. Thus, the control can be used to determine the effects related to the procedure or agent or variable etc. For example, if the effect of a test molecule on a cell was in question, one could a) simply record the characteristics of the cell in the presence of the molecule, b) perform a and then also record the effects of adding a control molecule with a known activity or lack of activity, or a control composition (e.g., the assay buffer solution (the vehicle)) and then compare effects of the test molecule to the control. In certain circumstances once a control is performed the control can be used as a standard, in which the control experiment does not have to be performed again and in other circumstances the control experiment should be run in parallel each time a comparison will be made.

25. Detect

Detect or like terms refer to an ability of the apparatus and methods of the disclosure to discover or sense a molecule- or a marker-induced cellular response and to distinguish the sensed responses for distinct molecules.

26. Direct Action (of a Drug Candidate Molecule)

A “direct action” or like terms is a result (of a drug candidate molecule“) acting independently on a cell.

27. DMR Signal

A “DMR signal” or like terms refers to the signal of cells measured with an optical biosensor that is produced by the response of a cell upon stimulation.

28. DMR Response

A “DMR response” or like terms is a biosensor response using an optical biosensor. The DMR refers to dynamic mass redistribution or dynamic cellular matter redistribution. A P-DMR is a positive DMR response, a N-DMR is a negative DMR response, and a RP-DMR is a recovery P-DMR response.

29. Drug Candidate Molecule

A drug candidate molecule or like terms is a test molecule which is being tested for its ability to function as a drug or a pharmacophore. This molecule may be considered as a lead molecule.

30. Efficacy

Efficacy or like terms is the capacity to produce a desired size of an effect under ideal or optimal conditions. It is these conditions that distinguish efficacy from the related concept of effectiveness, which relates to change under real-life conditions. Efficacy is the relationship between receptor occupancy and the ability to initiate a response at the molecular, cellular, tissue or system level.

31. Higher and Inhibit and Like Words

The terms higher, increases, elevates, or elevation or like terms or variants of these terms, refer to increases above basal levels, e.g., as compared a control. The terms low, lower, reduces, decreases or reduction or like terms or variation of these terms, refer to decreases below basal levels, e.g., as compared to a control. For example, basal levels are normal in vivo levels prior to, or in the absence of, or addition of a molecule such as an agonist or antagonist to a cell. Inhibit or forms of inhibit or like terms refers to reducing or suppressing.

32. Hierarchical Clustering

The Hierarchical clustering method is a method of cluster analysis which seeks to build a hierarchy of clusters based on linkages.

Hierarchical clustering is a method of cluster analysis which seeks to build a hierarchy of clusters (see Hastie, T., Tibshirani, R., Friedman, J. (2009). “14.3.12 Hierarchical clustering” in The Elements of Statistical Learning (2nd ed.). New York: Springer. pp. 520-528 and references cited therein). Hierarchical clustering does not require a preset number of clusters. Hierarchical clustering builds a “tree” in which each leaf represents an individual data item and each interior node, or branch point represents a cluster of data items.

Strategies for hierarchical clustering generally fall into two types: agglomerative and divisive. Agglomerative clustering is a “bottom up” approach—each observation starts in its own cluster, and pairs of clusters are merged as one moves up the hierarchy. Divisive clustering is a “top down” approach—all observations start in one cluster, and splits are performed recursively as one moves down the hierarchy. In order to decide which clusters should be combined (for agglomerative), or where a cluster should be split (for divisive), a measure of dissimilarity between sets of observations is required. In most methods of hierarchical clustering, this is achieved by use of an appropriate distance metric (a measure of distance between pairs of observations), and a linkage criteria which specifies the dissimilarity of sets as a function of the pairwise distances of observations in the sets. The choice of an appropriate metric will influence the shape of the clusters, as some elements may be close to one another according to one distance and farther away according to another.

Common distance metrics include Euclidean distance, squared Euclidean distance, Manhattan distance, maximum distance, Mahalanobis distance, and cosine similarity. The Euclidean distance is found to be the most preferred metric for label-free integrative pharmacology applications, and is used throughout in the disclosed experimental examples. Similarity and dissimilarity are two distance functions between two nodes. The similarity and dissimilarity is measured based on distance between the edge attributes of nodes.

Hierarchical clustering builds a dendrogram (binary tree) such that more similar nodes are likely to connect more closely into the tree. Hierarchical clustering is useful for organizing the data to get a sense of the pairwise relationships between data values and between clusters. The dendrogram is generated by using linkage criteria. The linkage is referred to as a measure of “closeness” between the two groups. The linkage criteria determines the distance between sets of observations as a function of the pairwise distances between observations. There are four different types of linkage. In agglomerative clustering techniques such as hierarchical clustering, at each step in the algorithm, the two closest groups are chosen to be merged. The linkage methods include: (1) pairwise average-linkage (i.e., the mean distance between all pairs of elements in the two groups0, (2) pairwise single-linkage (i.e., the smallest distance between all pairs of elements in the two groups), (3) pairwise maximum-linkage (i.e., the largest distance between all pairs of elements in the two groups) and (4) pairwise centroid-linkage (i.e., the distance between the centroids of all pairs of elements in the two groups). The pairwise maximum-linkage is found to be the most preferred for label-free integrative pharmacology applications.

For Hierarchical clustering, there are several ways to calculate the distance matrix that is used to build the cluster. Typically, the distances represent the distances between two rows (usually representing nodes) in the matrix. The distance metrics used includes, but not limited to, (1) Euclidean distance which is the simple two-dimensional Euclidean distance between two rows calculated as the square root of the sum of the squares of the differences between the values; (2) City-block distance which is the sum of the absolute value of the differences between the values in the two rows; (3) Pearson correlation which is the Pearson product-moment coefficient of the values in the two rows being compared. This value is calculated by dividing the covariance of the two rows by the product of their standard deviations; (4) Pearson correlation, absolute value which is similar to the value indicated in (3), but using the absolute value of the covariance of the two rows; (5) Uncentered correlation which is the standard Pearson correlation includes terms to center the sum of squares around zero. This metric makes no attempt to center the sum of squares. (6) Centered correlation, absolute value which is similar to the value indicated in (5), but using the absolute value of the covariance of the two rows; (7) Spearman's rank correlation which is Spearman's rank correlation (ρ) is a non-parametric measure of the correlation between the two rows; (8) Kendall's tau which ranks correlation coefficient (τ) between the two rows. The choice of distance metric for label-free integrative pharmacology is found to be dependent on the types of data. For similarity analysis based on the molecule biosensor primary indices, the uncentered correlation with absolute value is preferable. However, for similarity analysis based on the molecule modulation indices, both the uncentered correlation with absolute value and the centered correlation with absolute value can be used.

The similarity analysis can further use a predefined clustering threshold (a density parameter, also termed as similarity threshold) to compute a similarity matrix. Such a threshold gives the boundary between similar and dissimilar objects, and thus is used to control the density of the clustering analysis. High (restrictive) values make it more expensive to add most of the edges, resulting in many small clusters. On the other hand, lower values make it cheap to add edges but expensive to remove them, resulting in few big clusters (meaning lower resolution). For label-free integrative pharmacology, the clustering threshold can be variable, and often depending on the desired resolution of clustering (e.g., at the cell type level, or at the specific pathway level, or at the specific target level).

For label-free integrative pharmacology, the data contain the list of all numeric node and edge attributes that can be used for hierarchical clustering. The node is often the molecule. The edge attribute represents the response of the molecules either alone (i.e., a given response at a specific time i for the molecule primary profile in a cell), or represents the modulation percentage of the molecule against a marker (i.e., the modulation percentage of the marker biosensor response, such as P-DMR, or N-DMR, by the molecule at a specific concentration). At least one edge attribute or one or more node attributes must be selected to perform the clustering. If an edge attribute is selected, the resulting matrix will be symmetric across the diagonal with nodes on both columns and rows. If multiple node attributes are selected, the attributes will define columns and the nodes will be the rows. Under certain circumstances, it may be desirable to cluster only a subset of the nodes in the network. For example, to identify molecules sharing a specific mode of action, only a subset of the nodes displaying such mode of action is examined (see example in FIG. 6).

For label-free integrative pharmacology approach, certain normalization or data pretreatments may be necessary for effectively clustering. For example, data filtering may be necessary. For similarity analysis based on molecule biosensor primary indices, an effective data filtering mean is to use the max-min difference (e.g., only molecules whose DMR signal having a max-min difference between different time points greater than 40 picometer within one hour post-stimulation are subject to similarity analysis). On the other hand, for similarity analysis based on molecule biosensor modulation indices, an effective data filtering mean is to ignore molecules whose biosensor modulation indices contain less than 15% modulation against all the markers, or a specific set of markers.

For label-free integrative pharmacology approach, a two-dimensional or two-way clustering analysis is preferred. Two-way clustering, co-clustering or biclustering are clustering methods where not only the nodes (i.e., objects, molecules) are clustered but also the features (i.e., edge attributes) of the nodes, i.e., if the data is represented in a data matrix, the rows and columns are clustered simultaneously. Such analysis includes clustering both attributes and nodes. In such a method, the clustering algorithm will be run twice, first with the rows in the matrix representing the nodes and the columns representing the attributes. The resulting dendrogram provides a hierarchical clustering of the nodes given the values of the attributes. In the second pass, the matrix is transposed and the rows represent the attribute values. This provides a dendrogram clustering the attributes. Both the node-based and the attribute-base dendrograms can be viewed. As shown in disclosed examples, the first clustering allows one to cluster molecules in term of their similarity and dissimilarity. The second clustering will serve different purposes, depending on the types of label-free integrative pharmacology analysis. For analysis based on the molecule biosensor primary indices, this clustering allows one to identify the minimal numbers of kinetic parameters needed for effective clustering molecules, and also to investigate the regulation mechanisms of the kinetic responses (i.e., pathways involved in the early response, versus pathways involved in the late response of a molecule acting on the cell(s)). For analysis based on the molecule biosensor modulation indices, this clustering not only allows one to identify the polypharmacology and phenotypic pharmacology of a molecule, but also to investigate the pathway interactions among different markers acting in a specific cell or a panel of cells.

The similarity analysis typically leads to dendrogram which consists of interconnected or independent clusters of molecules, each cluster of molecules share similar mode(s) of action (i.e., pharmacology). The clusters can also be viewed as a heat map. A heat map is a graphical representation of data where the values taken by a variable in a two-dimensional map are represented as colors. A very similar presentation form is a tree map. Heat maps originated in 2D displays of the values in a data matrix. Positive values are represented by red color squares and negative values by green color squares. Large values are displayed by darker color squares and smaller values by lighter color squares (exampled in FIGS. 4, 5, 6 and 7). Cluster results are often permuted the rows and the columns of a matrix to place similar values near each other according to the clustering. Similarity analysis for gene expression analysis and protein network analysis has resulted in three types of popular heat map displays, including HeatMapView (unclustered), Eisen TreeView, and Eisen KnnView. These heat map display approaches can be directly used to view the clusters and relations of molecules in terms of their label-free integrative pharmacology. Gene expression analysis often shows the results of hierarchically clustering of the nodes (i.e, genes) and a number of node attributes (typically expression data under different experimental conditions). Clustering based on label-free integrative pharmacology also displays the results of hierarchically clustering of the nodes (i.e., the molecules) and a number of node attributes. However, the node attributes used are dependent on the types of analysis. For the molecule biosensor primary indices-based similarity analysis, the node attributes are the real values of a molecule biosensor signal at a number of time points post stimulation of cells with the molecule. Alternatively, for the molecule biosensor primary indices-based functional selectivity analysis, the node attributes can also be the predetermined kinetic parameters (e.g., amplitude, kinetics and duration of a P-DMR and/or a N-DMR event). On the other hand, for the molecule biosensor modulation indices based similarity analysis, the node attributes can be the modulation percentages of the molecules against each marker in a cell. The modulation percentage is often calculated by normalizing the marker biosensor response in the presence of a molecule to the marker biosensor response in the absence of the molecule. Such normalization is often based on signal amplitudes of a particular biosensor event (e.g., P-DMR, N-DMR or RP-DMR) but not the kinetics of the respective event, since it is the signal amplitude, but not the kinetics, that is associated with molecule efficacy (when the molecule is an agonist or activator for a pathway or a cellular process) or potency (when the molecule is an antagonist or inhibitor for a pathway or a cellular process).

Among the heat map display approaches developed to date, the Eisen TreeView is the most common approach. Here Hierarchical clustering results are usually displayed with a color-coded “Heat Map” of the data values and the dendrogram from clustering. Alternatively, when k-means clustering is used, the results can be shown with the Eisen KnnView.

33. In the Presence of the Molecule

“in the presence of the molecule” or like terms refers to the contact or exposure of the cultured cell with the molecule. The contact or exposure can be taken place before, or at the time, the stimulus is brought to contact with the cell.

34. Index

An index or like terms is a collection of data. For example, an index can be a list, table, file, or catalog that contains one or more modulation profiles. It is understood that an index can be produced from any combination of data. For example, a DMR profile can have a P-DMR, a N-DMR, and a RP-DMR. An index can be produced using the completed date of the profile, the P-DMR data, the N-DMR data, the RP-DMR data, or any point within these, or in combination of these or other data. The index is the collection of any such information. Typically, when comparing indexes, the indexes are of like data, i.e. P-DMR to P-DMR data.

i. Biosensor Index

A “biosensor index” or like terms is an index made up of a collection of biosensor data. A biosensor index can be a collection of biosensor profiles, such as primary profiles, or secondary profiles. The index can be comprised of any type of data. For example, an index of profiles could be comprised of just an N-DMR data point, it could be a P-DMR data point, or both or it could be an impedence data point. It could be all of the data points associated with the profile curve.

ii. DMR index

A “DMR index” or like terms is a biosensor index made up of a collection of DMR data.

35. K-Means

The K-Means clustering is a partitioning algorithm that divides the data into k non-overlapping clusters, where k is an input parameter, and also the Number of clusters (see Hastie, T., Tibshirani, R., Friedman, J. (2009). The Elements of Statistical Learning (2nd ed.). New York: Springer. pp. 509-513 and references cited therein). One of the challenges in k-Means clustering is that the number of clusters must be chosen in advance, and in general are close to the square root of ½ of the number of nodes.

36. Known Molecule

A known molecule or like terms is a molecule with known pharmacological/biological/physiological/pathophysiological activity whose precise mode of action(s) may be known or unknown.

37. Known Modulator

A known modulator or like terms is a modulator where at least one of the targets is known with a known affinity. For example, a known modulator could be a PI3K inhibitor, a PKA inhibitor, a GPCR antagonist, a GPCR agonist, a RTK inhibitor, an epidermal growth factor receptor neutralizing antibody, or a phosphodiesterase inhibition, a PKC inhibitor or activator, etc.

38. Known Modulator Biosensor Index

A “known modulator biosensor index” or like terms is a modulator biosensor index produced by data collected for a known modulator. For example, a known modulator biosensor index can be made up of a profile of the known modulator acting on the panel of cells, and the modulation profile of the known modulator against the panels of markers, each panel of markers for a cell in the panel of cells.

39. Known Modulator DMR Index

A “known modulator DMR index” or like terms is a modulator DMR index produced by data collected for a known modulator. For example, a known modulator DMR index can be made up of a profile of the known modulator acting on the panel of cells, and the modulation profile of the known modulator against the panels of markers, each panel of markers for a cell in the panel of cells.

40. Ligand

A ligand or like terms is a substance or a composition or a molecule that is able to bind to and form a complex with a biomolecule to serve a biological purpose. Actual irreversible covalent binding between a ligand and its target molecule is rare in biological systems. Ligand binding to receptors alters the chemical conformation, i.e., the three dimensional shape of the receptor protein. The conformational state of a receptor protein determines the functional state of the receptor. The tendency or strength of binding is called affinity. Ligands include substrates, blockers, inhibitors, activators, and neurotransmitters. Radioligands are radioisotope labeled ligands, while fluorescent ligands are fluorescently tagged ligands; both can be considered as ligands are often used as tracers for receptor biology and biochemistry studies. Ligand and modulator are used interchangeably.

41. Library

A library or like terms is a collection. The library can be a collection of anything disclosed herein. For example, it can be a collection, of indexes, an index library; it can be a collection of profiles, a profile library; or it can be a collection of DMR indexes, a DMR index library; Also, it can be a collection of molecule, a molecule library; it can be a collection of cells, a cell library; it can be a collection of markers, a marker library; a library can be for example, random or non-random, determined or undetermined. For example, disclosed are libraries of DMR indexes or biosensor indexes of known modulators.

42. Marker

A marker or like terms is a ligand which produces a signal in a biosensor cellular assay. The signal is, must also be, characteristic of at least one specific cell signaling pathway(s) and/or at least one specific cellular process(es) mediated through at least one specific target(s). The signal can be positive, or negative, or any combinations (e.g., oscillation).

43. Marker Panel

A “marker panel” or like terms is a panel which comprises at least two markers. The markers can be for different pathways, the same pathway, different targets, or even the same targets.

44. Marker Biosensor Index

A “marker biosensor index” or like terms is a biosensor index produced by data collected for a marker. For example, a marker biosensor index can be made up of a profile of the marker acting on the panel of cells, and the modulation profile of the marker against the panels of markers, each panel of markers for a cell in the panel of cells.

45. Marker DMR Index

A “marker biosensor index” or like terms is a biosensor DMR index produced by data collected for a marker. For example, a marker DMR index can be made up of a profile of the marker acting on the panel of cells, and the modulation profile of the marker against the panels of markers, each panel of markers for a cell in the panel of cells.

46. Markov Clustering Algorithm

Markov Clustering Algorithm (MCL) is a fast divisive clustering algorithm for graphs based on simulation of the flow in the graph. Unlike most hierarchical clustering procedures, this algorithm considers the connectivity properties of the underlying network. It has been used to derive complexes from protein interaction data. MCL was shown to be especially effective for clustering protein interactions in that it possesses a high degree of noise-tolerance in comparison to other algorithms such as the Molecular Complex Detection (MCODE), FORCE, and Super Paramagnetic Clustering (SPC). All these algorithms create collapsible “meta nodes” to allow interactive exploration of the putative family associations, and thus are often used for clustering similarity networks to look for protein families (and putative functional similarities).

47. Material

Material is the tangible part of something (chemical, biochemical, biological, or mixed) that goes into the makeup of a physical object.

48. Mimic

As used herein, “mimic” or like terms refers to performing one or more of the functions of a reference object. For example, a molecule mimic performs one or more of the functions of a molecule.

49. Modulate

To modulate, or forms thereof, means either increasing, decreasing, or maintaining a cellular activity mediated through a cellular target. It is understood that wherever one of these words is used it is also disclosed that it could be 1%, 5%, 10%, 20%, 50%, 100%, 500%, or 1000% increased from a control, or it could be 1%, 5%, 10%, 20%, 50%, or 100% decreased from a control.

50. Modulator

A modulator or like terms is a ligand that controls the activity of a cellular target. It is a signal modulating molecule binding to a cellular target, such as a target protein.

51. Modulation Comparison

A “modulation comparison” or like terms is a result of normalizing a primary profile and a secondary profile.

52. Modulator Biosensor Index

A “modulator biosensor index” or like terms is a biosensor index produced by data collected for a modulator. For example, a modulator biosensor index can be made up of a profile of the modulator acting on the panel of cells, and the modulation profile of the modulator against the panels of markers, each panel of markers for a cell in the panel of cells.

53. Modulator DMR Index

A “modulator DMR index” or like terms is a DMR index produced by data collected for a modulator. For example, a modulator DMR index can be made up of a profile of the modulator acting on the panel of cells, and the modulation profile of the modulator against the panels of markers, each panel of markers for a cell in the panel of cells.

54. Modulate the Biosensor Signal of a Marker

“Modulate the biosensor signal or like terms is to cause changes of the biosensor signal or profile of a cell in response to stimulation with a marker.

55. Modulate the DMR Signal

“Modulate the DMR signal or like terms is to cause changes of the DMR signal or profile of a cell in response to stimulation with a marker.

56. Molecule

As used herein, the terms “molecule” or like terms refers to a biological or biochemical or chemical entity that exists in the form of a chemical molecule or molecule with a definite molecular weight. A molecule or like terms is a chemical, biochemical or biological molecule, regardless of its size.

Many molecules are of the type referred to as organic molecules (molecules containing carbon atoms, among others, connected by covalent bonds), although some molecules do not contain carbon (including simple molecular gases such as molecular oxygen and more complex molecules such as some sulfur-based polymers). The general term “molecule” includes numerous descriptive classes or groups of molecules, such as proteins, nucleic acids, carbohydrates, steroids, organic pharmaceuticals, small molecule, receptors, antibodies, and lipids. When appropriate, one or more of these more descriptive terms (many of which, such as “protein,” themselves describe overlapping groups of molecules) will be used herein because of application of the method to a subgroup of molecules, without detracting from the intent to have such molecules be representative of both the general class “molecules” and the named subclass, such as proteins. Unless specifically indicated, the word “molecule” would include the specific molecule and salts thereof, such as pharmaceutically acceptable salts.

57. Molecule Mixture

A molecule mixture or like terms is a mixture containing at least two molecules. The two molecules can be, but not limited to, structurally different (i.e., enantiomers), or compositionally different (e.g., protein isoforms, glycoform, or an antibody with different poly(ethylene glycol) (PEG) modifications), or structurally and compositionally different (e.g., unpurified natural extracts, or unpurified synthetic compounds).

58. Molecule Biosensor Index

A “molecule biosensor index” or like terms is a biosensor index produced by data collected for a molecule. For example, a molecule biosensor index can be made up of a profile of the molecule acting on the panel of cells, and the modulation profile of the molecule against the panels of markers, each panel of markers for a cell in the panel of cells.

59. Molecule DMR Index

A “molecule DMR index” or like terms is a DMR index produced by data collected for a molecule. For example, a molecule biosensor index can be made up of a profile of the molecule acting on the panel of cells, and the modulation profile of the molecule against the panels of markers, each panel of markers for a cell in the panel of cells.

60. Molecule Index

A “molecule index” or like terms is an index related to the molecule.

61. Molecule-Treated Cell

A molecule-treated cell or like terms is a cell that has been exposed to a molecule.

62. Molecule Modulation Index

A “molecule modulation index” or like terms is an index to display the ability of the molecule to modulate the biosensor output signals of the panels of markers acting on the panel of cells. The modulation index is generated by normalizing a specific biosensor output signal parameter of a response of a cell upon stimulation with a marker in the presence of a molecule against that in the absence of any molecule.

63. Molecule Pharmacology

Molecule pharmacology or the like terms refers to the systems cell biology or systems cell pharmacology or mode(s) of action of a molecule acting on a cell. The molecule pharmacology is often characterized by, but not limited, toxicity, ability to influence specific cellular process(es) (e.g., proliferation, differentiation, reactive oxygen species signaling), or ability to modulate a specific cellular target (e.g, PI3K, PKA, PKC, PKG, JAK2, MAPK, MEK2, or actin).

64. Normalizing

Normalizing or like terms means, adjusting data, or a profile, or a response, for example, to remove at least one common variable. For example, if two responses are generated, one for a marker acting a cell and one for a marker and molecule acting on the cell, normalizing would refer to the action of comparing the marker-induced response in the absence of the molecule and the response in the presence of the molecule, and removing the response due to the marker only, such that the normalized response would represent the response due to the modulation of the molecule against the marker. A modulation comparison is produced by normalizing a primary profile of the marker and a secondary profile of the marker in the presence of a molecule (modulation profile).

65. Optional

“Optional” or “optionally” or like terms means that the subsequently described event or circumstance can or cannot occur, and that the description includes instances where the event or circumstance occurs and instances where it does not. For example, the phrase “optionally the composition can comprise a combination” means that the composition may comprise a combination of different molecules or may not include a combination such that the description includes both the combination and the absence of the combination (i.e., individual members of the combination).

66. Or

The word “or” or like terms as used herein means any one member of a particular list and also includes any combination of members of that list.

67. Profile

A profile or like terms refers to the data which is collected for a composition, such as a cell. A profile can be collected from a label free biosensor as described herein.

i. Primary Profile

A “primary profile” or like terms refers to a biosensor response or biosensor output signal or profile which is produced when a molecule contacts a cell. Typically, the primary profile is obtained after normalization of initial cellular response to the net-zero biosensor signal (i.e., baseline)

ii. Secondary Profile

A “secondary profile” or like terms is a biosensor response or biosensor output signal of cells in response to a marker in the presence of a molecule. A secondary profile can be used as an indicator of the ability of the molecule to modulate the marker-induced cellular response or biosensor response.

iii. Modulation Profile

A “modulation profile” or like terms is the comparison between a secondary profile of the marker in the presence of a molecule and the primary profile of the marker in the absence of any molecule. The comparison can be by, for example, subtracting the primary profile from secondary profile or subtracting the secondary profile from the primary profile or normalizing the secondary profile against the primary profile.

68. Panel

A panel or like terms is a predetermined set of specimens (e.g., markers, or cells, or pathways). A panel can be produced from picking specimens from a library.

69. Positive Control

A “positive control” or like terms is a control that shows that the conditions for data collection can lead to data collection.

70. Potentiate

Potentiate, potentiated or like terms refers to an increase of a specific parameter of a biosensor response of a marker in a cell caused by a molecule. By comparing the primary profile of a marker with the secondary profile of the same marker in the same cell in the presence of a molecule, one can calculate the modulation of the marker-induced biosensor response of the cells by the molecule. A positive modulation means the molecule to cause increase in the biosensor signal induced by the marker.

71. Potency

Potency or like terms is a measure of molecule activity expressed in terms of the amount required to produce an effect of given intensity. For example, a highly potent drug evokes a larger response at low concentrations. The potency is proportional to affinity and efficacy. Affinity is the ability of the drug molecule to bind to a receptor.

72. Publications

Throughout this application, various publications are referenced. The disclosures of these publications in their entireties are hereby incorporated by reference into this application in order to more fully describe the state of the art to which this pertains. The references disclosed are also individually and specifically incorporated by reference herein for the material contained in them that is discussed in the sentence in which the reference is relied upon.

73. Receptor

A receptor or like terms is a protein molecule embedded in either the plasma membrane or cytoplasm of a cell, to which a mobile signaling (or “signal”) molecule may attach. A molecule which binds to a receptor is called a “ligand,” and may be a peptide (such as a neurotransmitter), a hormone, a pharmaceutical drug, or a toxin, and when such binding occurs, the receptor goes into a conformational change which ordinarily initiates a cellular response. However, some ligands merely block receptors without inducing any response (e.g. antagonists). Ligand-induced changes in receptors result in physiological changes which constitute the biological activity of the ligands.

74. “Robust Biosensor Signal”

A “robust biosensor signal” is a biosensor signal whose amplitude(s) is significantly (such as 3×, 10×, 20×, 100×, or 1000×) above either the noise level, or the negative control response. The negative control response is often the biosensor response of cells after addition of the assay buffer solution (i.e., the vehicle). The noise level is the biosensor signal of cells without further addition of any solution. It is worthy of noting that the cells are always covered with a solution before addition of any solution.

75. “Robust DMR Signal”

A “robust DMR signal” or like terms is a DMR form of a “robust biosensor signal.”

76. Ranges

Ranges can be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that when a value is disclosed that “less than or equal to” the value, “greater than or equal to the value” and possible ranges between values are also disclosed, as appropriately understood by the skilled artisan. For example, if the value “10” is disclosed the “less than or equal to 10” as well as “greater than or equal to 10” is also disclosed. It is also understood that the throughout the application, data is provided in a number of different formats, and that this data, represents endpoints and starting points, and ranges for any combination of the data points. For example, if a particular data point “10” and a particular data point 15 are disclosed, it is understood that greater than, greater than or equal to, less than, less than or equal to, and equal to 10 and 15 are considered disclosed as well as between 10 and 15. It is also understood that each unit between two particular units are also disclosed. For example, if 10 and 15 are disclosed, then 11, 12, 13, and 14 are also disclosed.

77. Response

A response or like terms is any reaction to any stimulation.

78. Sample

By sample or like terms is meant an animal, a plant, a fungus, etc.; a natural product, a natural product extract, etc.; a tissue or organ from an animal; a cell (either within a subject, taken directly from a subject, or a cell maintained in culture or from a cultured cell line); a cell lysate (or lysate fraction) or cell extract; or a solution containing one or more molecules derived from a cell or cellular material (e.g. a polypeptide or nucleic acid), which is assayed as described herein. A sample may also be any body fluid or excretion (for example, but not limited to, blood, urine, stool, saliva, tears, bile) that contains cells or cell components.

79. Substance

A substance or like terms is any physical object. A material is a substance. Molecules, ligands, markers, cells, proteins, and DNA can be considered substances. A machine or an article would be considered to be made of substances, rather than considered a substance themselves.

80. Subject

As used throughout, by a subject or like terms is meant an individual. Thus, the “subject” can include, for example, domesticated animals, such as cats, dogs, etc., livestock (e.g., cattle, horses, pigs, sheep, goats, etc.), laboratory animals (e.g., mouse, rabbit, rat, guinea pig, etc.) and mammals, non-human mammals, primates, non-human primates, rodents, birds, reptiles, amphibians, fish, and any other animal. In one aspect, the subject is a mammal such as a primate or a human. The subject can be a non-human.

81. Test Molecule

A test molecule or like terms is a molecule which is used in a method to gain some information about the test molecule. A test molecule can be an unknown or a known molecule.

82. Treating

Treating or treatment or like terms can be used in at least two ways. First, treating or treatment or like terms can refer to administration or action taken towards a subject. Second, treating or treatment or like terms can refer to mixing any two things together, such as any two or more substances together, such as a molecule and a cell. This mixing will bring the at least two substances together such that a contact between them can take place.

When treating or treatment or like terms is used in the context of a subject with a disease, it does not imply a cure or even a reduction of a symptom for example. When the term therapeutic or like terms is used in conjunction with treating or treatment or like terms, it means that the symptoms of the underlying disease are reduced, and/or that one or more of the underlying cellular, physiological, or biochemical causes or mechanisms causing the symptoms are reduced. It is understood that reduced, as used in this context, means relative to the state of the disease, including the molecular state of the disease, not just the physiological state of the disease.

83. Trigger

A trigger or like terms refers to the act of setting off or initiating an event, such as a response.

84. Values

Specific and preferred values disclosed for components, ingredients, additives, cell types, markers, and like aspects, and ranges thereof, are for illustration only; they do not exclude other defined values or other values within defined ranges. The compositions, apparatus, and methods of the disclosure include those having any value or any combination of the values, specific values, more specific values, and preferred values described herein.

Thus, the disclosed methods, compositions, articles, and machines, can be combined in a manner to comprise, consist of, or consist essentially of, the various components, steps, molecules, and composition, and the like, discussed herein. They can be used, for example, in methods for characterizing a molecule including a ligand as defined herein; a method of producing an index as defined herein; or a method of drug discovery as defined herein.

85. Unknown Molecule

An unknown molecule or like terms is a molecule with unknown biological/pharmacological/physiological/pathophysiological activity. An

86. Data Output

A data output refers to the collected result occurring after performing an assay using an analytical machine, such as a label free biosensor. For example, the data output of a label free biosensor could be a DMR signal. It is understood that data output can be manipulated, for example, into an Index. It is also understood that there can be any kind of data output that the assay is performed with, such as a molecule, Marker, inhibitor, marker-molecule, etc. It is also understood that any two outputs can be compared, such as a molecule data output and a data output forming a comparison. Typically, such a comparison will be performed with analogous data outputs, such as a DMR data output to a DMR data output.

### E. Examples

### 1. Example 1

### Experimental Procedures

i. Reagents

LY334370, Ro600175, adenosine, CCPA, CGS 21680, IB-MECA, (−) epinephrine, A 61603, (R)-(−)-phenylephrine, anadamide, dopamine, R(+)SKF38393, SKF 97541, histamine, nicotinic acid (NA), NPPB, forskolin, ATP, UTP, lysophosphatidic acid (LPA), sphingosine-1-phosphate (SIP), SB 205607, prostaglandin E2 (PGE2) were obtained from Tocris Chemical Inc. (St. Louis, Mo.). Poly(I:C), phorbol 12-myristate 13-acetate (PMA), and pinacidil were obtained from Sigma Chemical Co. (St. Louis, Mo.). ODN2006 was obtained from Imgenex (San Diego, Calif. 92121).

C5a, bradykinin, calcitonin gene-related peptide (CGRP), adrenomedulin, secretin, growth hormone-releasing factor (ovine) (GRF), orexin-A, vasoactive intestinal peptide (VIP), SFLLR, and SLIGKV, insulin-like growth factor 1 (IGF1), epidermal growth factor (EGF), and neurotensin (NT) was obtained from BaChem Americas Inc. (Torrance, Calif.). Several BioMol libraries including BioMol Kinase inhibitor library and ion channel modulator library were purchased from BIOMOL International, L.P. (Plymouth Meeting, Pa.). Cell culture reagents were all purchased from GIBCO cell culture products.

Mallotoxin (MTX) was obtained from BioMol International Inc (Plymouth Meeting, Pa.). Epic® 384 biosensor microplates cell culture compatible were obtained from Corning Inc. (Corning, N.Y.).

ii. Cell culture

Cells were typically grown using ˜1 to 2×10⁴ cells per well at passage 3 to 15 suspended in 50 μl of the corresponding culture medium in the biosensor microplate, and were cultured at 37° C. under air/5% CO₂ for ˜1 day. Except for A431 cells which underwent one day (at least 14 hours) culture followed by one day (at least 14 hours) starvation in serum free medium, all other cells were directly assayed without starvation. The confluency for all cells at the time of assays was ˜95% to 100%.

iii. Optical Biosensor System and Cell Assays

An Epic® beta version wavelength interrogation system (Corning Inc., Corning, N.Y.) was used for whole cell sensing. This system consists of a temperature-control unit, an optical detection unit, and an on-board liquid handling unit with robotics. The detection unit is centered on integrated fiber optics, and enables kinetic measures of cellular responses with a time interval of ˜15 sec.

The RWG biosensor is capable of detecting minute changes in local index of refraction near the sensor surface. Since the local index of refraction within a cell is a function of density and its distribution of biomass (e.g., proteins, molecular complexes), the biosensor exploits its evanescent wave to non-invasively detect ligand-induced dynamic mass redistribution in native cells. The evanescent wave extends into the cells and exponentially decays over distance, leading to a characteristic sensing volume of ˜150 nm, implying that any optical response mediated through the receptor activation only represents an average over the portion of the cell that the evanescent wave is sampling. The aggregation of many cellular events downstream the receptor activation determines the kinetics and amplitudes of a ligand-induced DMR.

For biosensor cellular assays, molecule solutions were made by diluting the stored concentrated solutions with the HBSS (1× Hanks balanced salt solution, plus 20 mM Hepes, pH 7.1), and transferred into a 384well polypropylene molecule storage plate to prepare a molecule source plate. Both molecule and marker source plates were made separately when a two-step assay was performed. In parallel, the cells were washed twice with the HBSS and maintained in 30 μl of the HBSS to prepare a cell assay plate. Both the cell assay plate and the molecule and marker source plate(s) were then incubated in the hotel of the reader system. After ˜1 hr of incubation the baseline wavelengths of all biosensors in the cell assay microplate were recorded and normalized to zero. Afterwards, a 2 to 10 minute continuous recording was carried out to establish a baseline, and to ensure that the cells reached a steady state. Cellular responses were then triggered by pipetting 10 μl of the marker solutions into the cell assay plate using the on-board liquid handler.

To study the influence of molecules on a marker-induced response, a second stimulation with the marker at a fixed dose (typically at EC80 or EC 100) was applied. The resonant wavelengths of all biosensors in the microplate were normalized again to establish a second baseline, right before the second stimulation. The two stimulations were usually separated by ˜1 hr.

All studies were carried out at a controlled temperature (28° C.). At least two independent sets of experiments, each with at least three replicates, were performed. The assay coefficient of variation was found to be <10%. A typical DMR signal of cells, as measured using Epic system, is a real time kinetic response which consists a baseline pre-stimulation (often normalized to zero), and a cellular response post stimulation.

### 2. Example 2

### Receptor Panning of Human Epidermoid Carcinoma A431

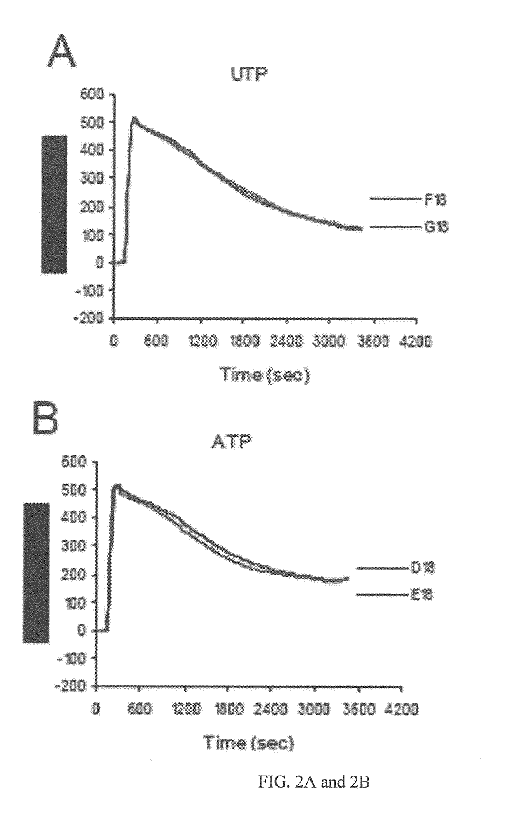

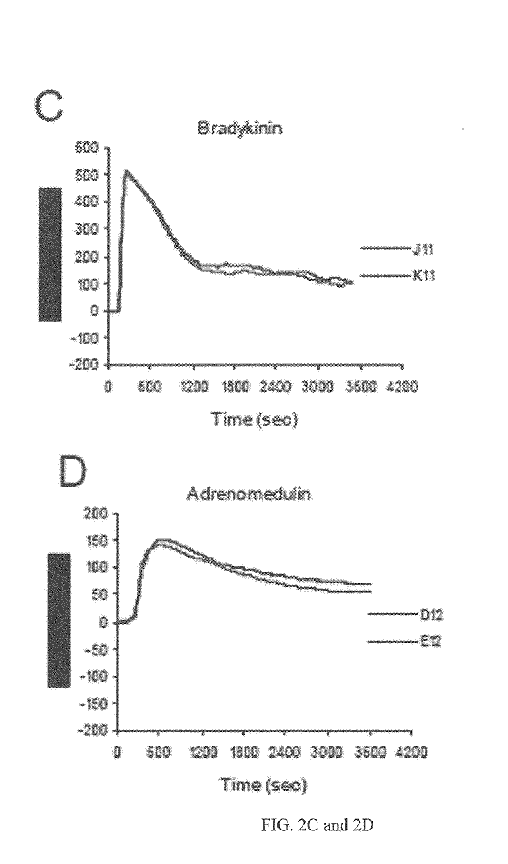

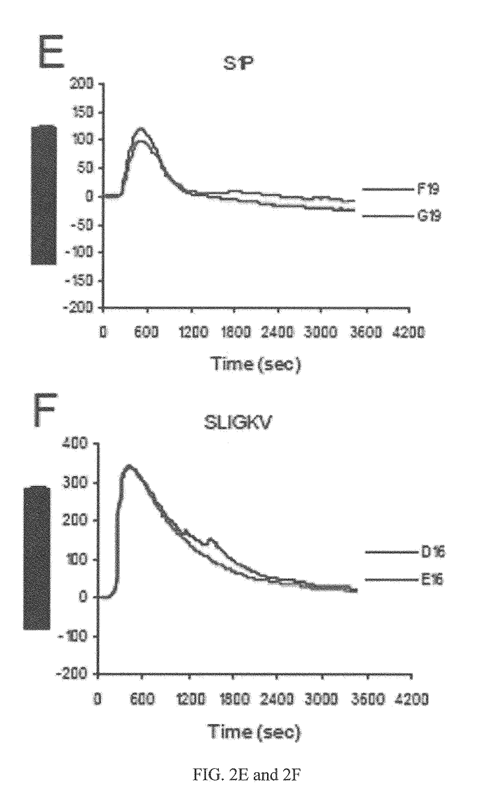

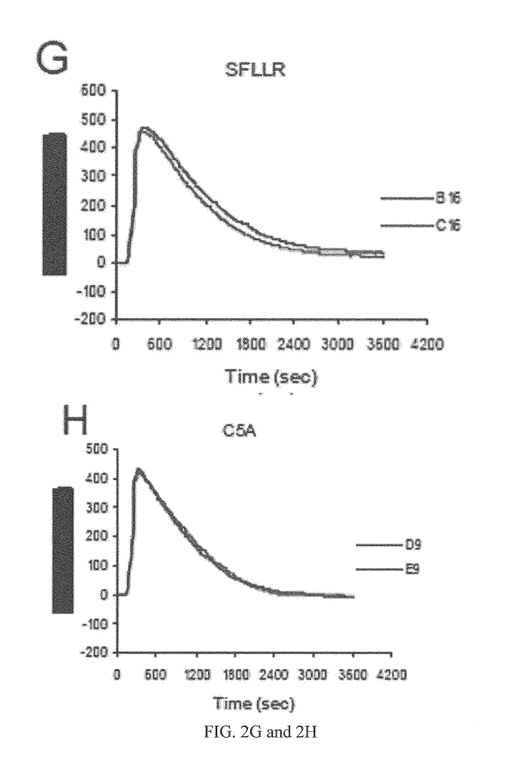

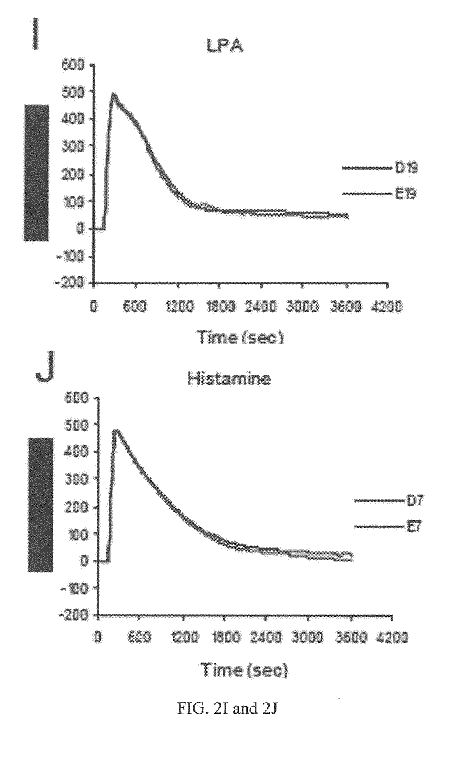

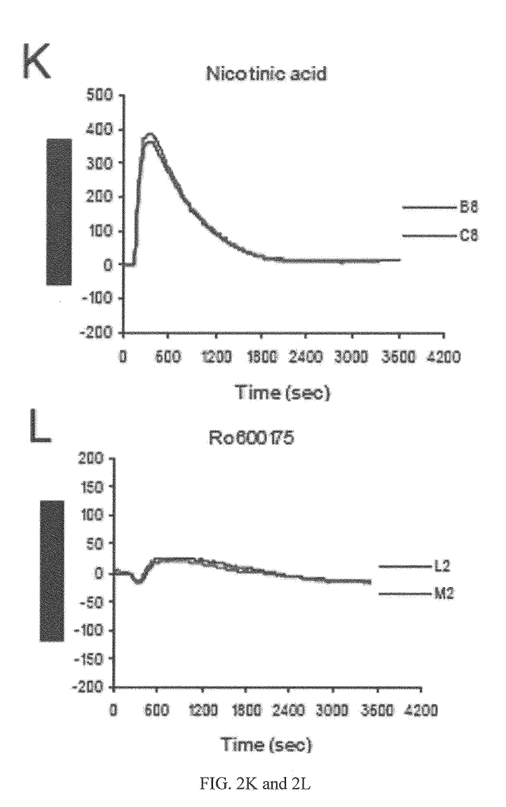

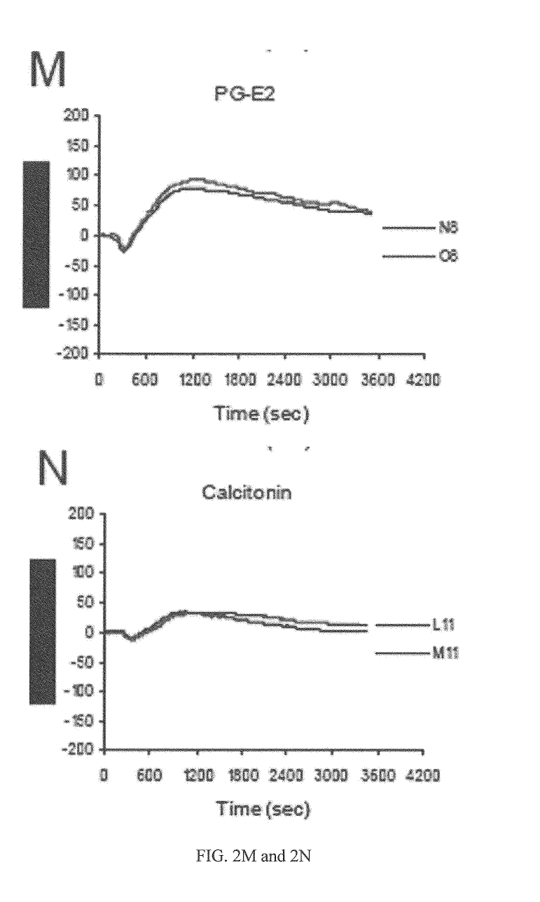

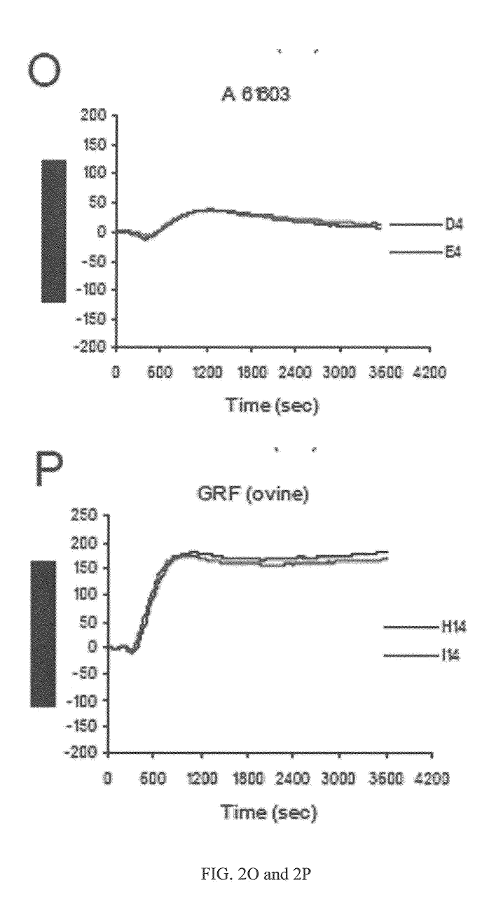

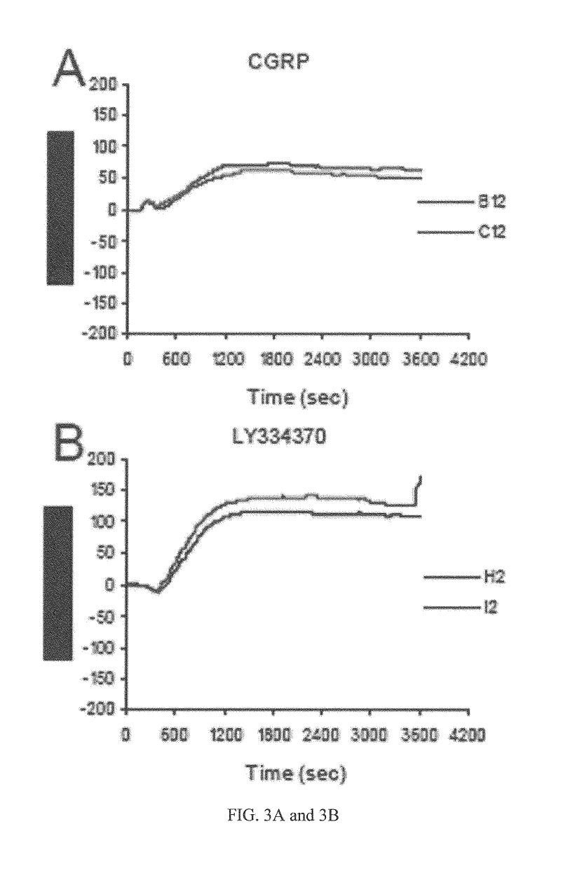

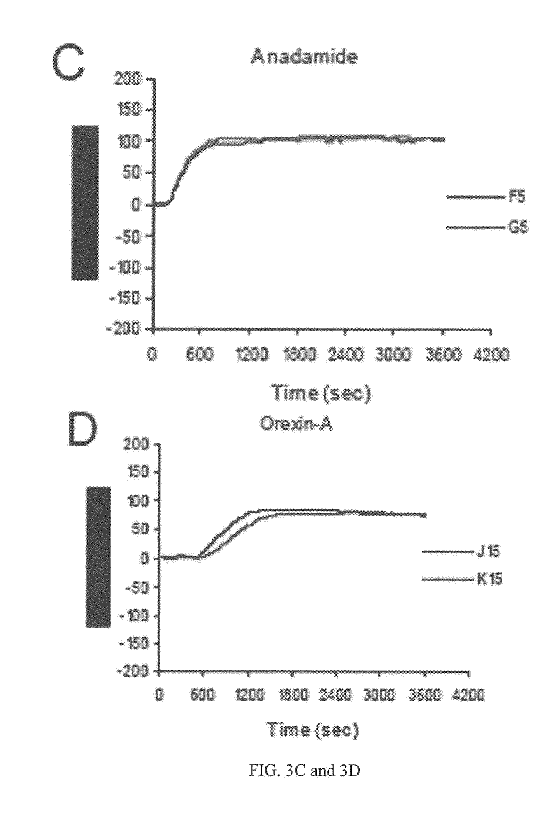

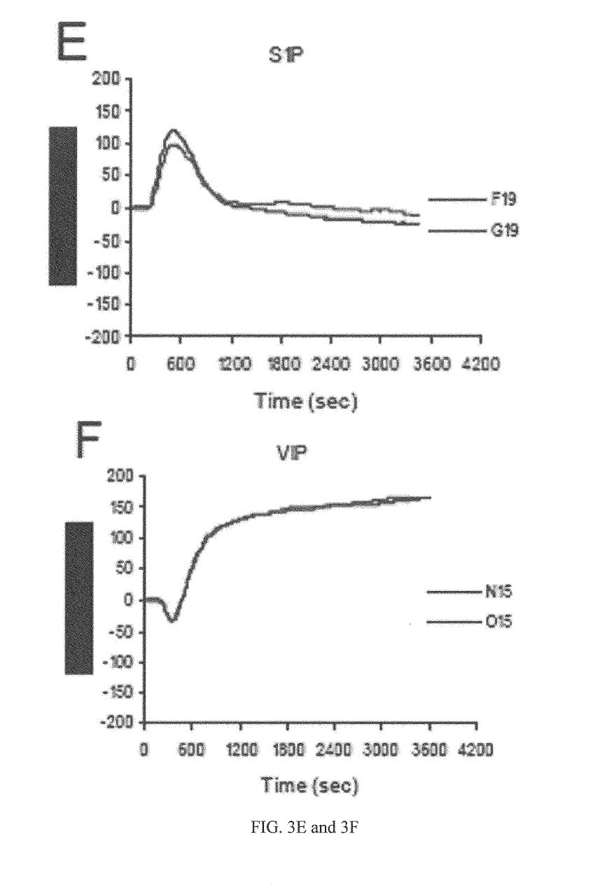

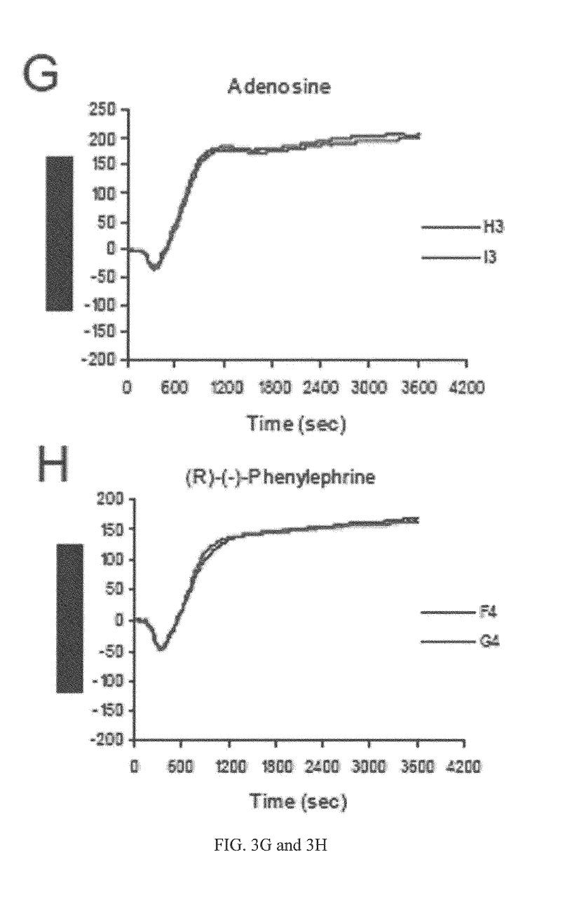

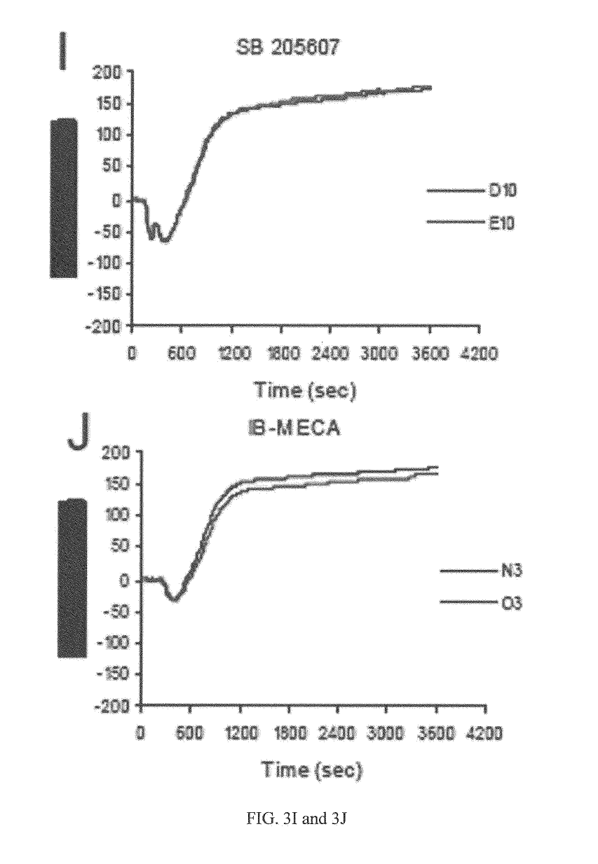

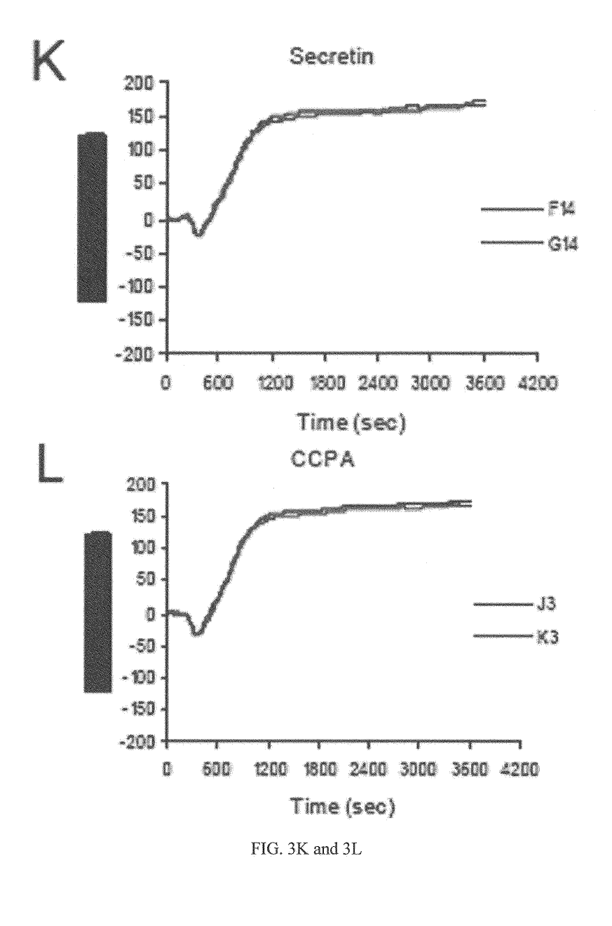

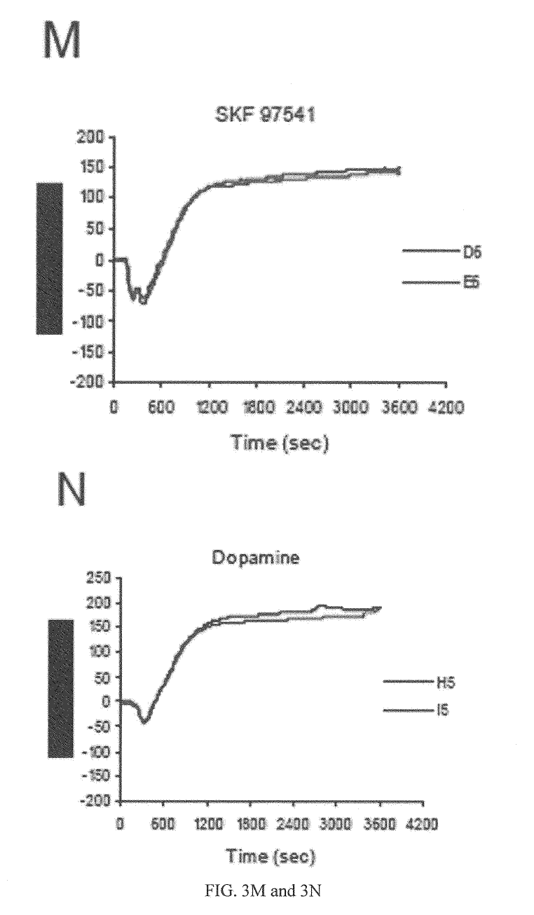

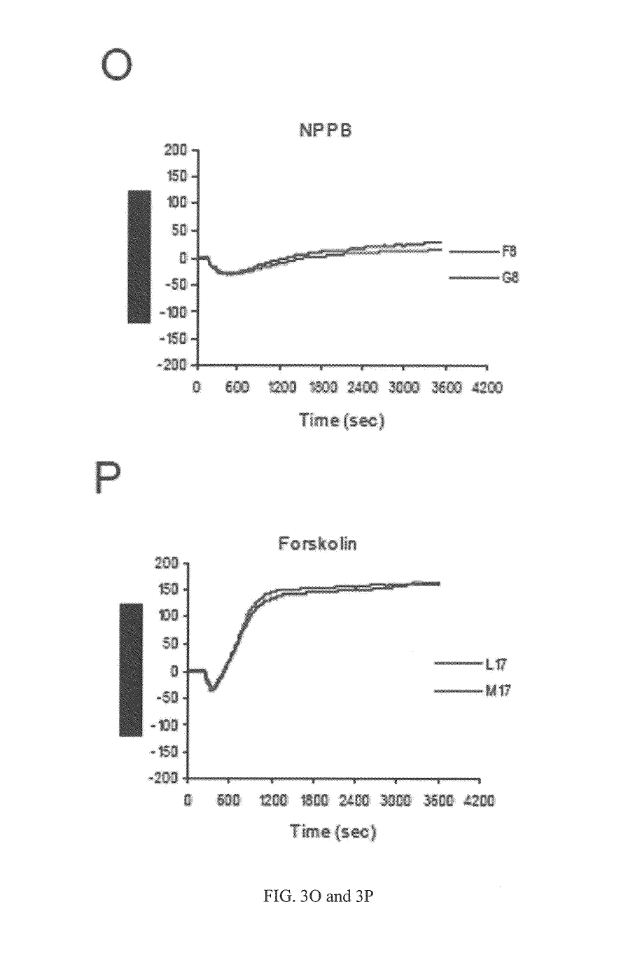

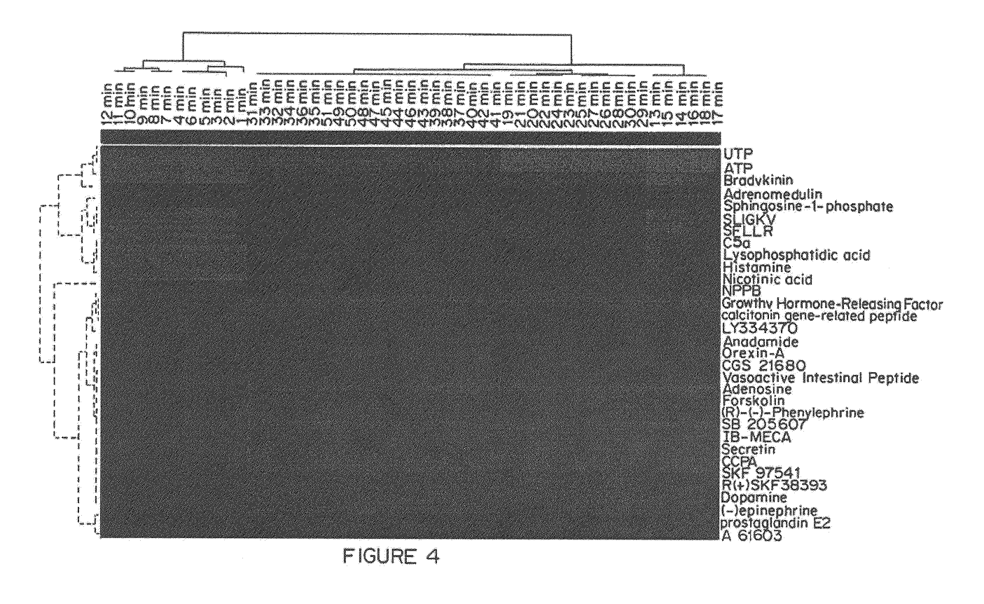

To pan endogenous G protein-coupled receptors (GPCRs) that are functional in label-free biosensor cellular assays, a library of known GPCR agonists was made. A431 cells were grown to monolayer on the Epic® 384well biosensor cell culture compatible microplates and subject to overnight starvation. After replacing the cell medium with 1×HBSS buffer and reaching equilibrium within the Epic® system, the cells were stimulated with known GPCR agonists, each at 10 micromolar. The known adenylate cyclase activator forskolin was also included as a positive control for the cAMP-PKA pathway. The representative dynamic mass redistribution (DMR) signals were presented in FIGS. 2 and 3. Results showed that A431 cells responded to a wide range of known GPCR agonists, and different GPCR agonists triggered DMR signals that are often different in fine features (e.g., kinetics, amplitudes, shape).

### 3. Example 3

### Clustering Known GPCR Agonist-Induced DMR Signals in A431 Cells

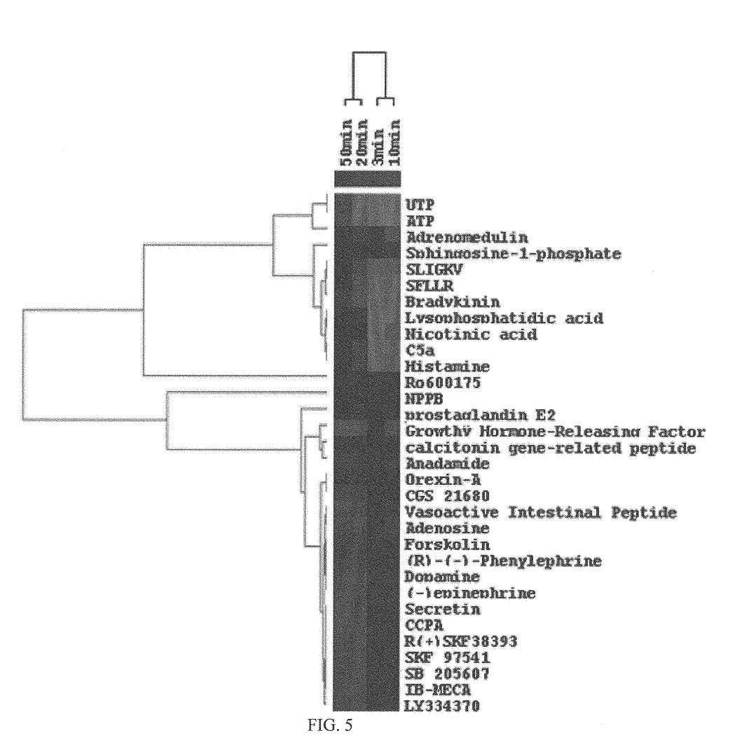

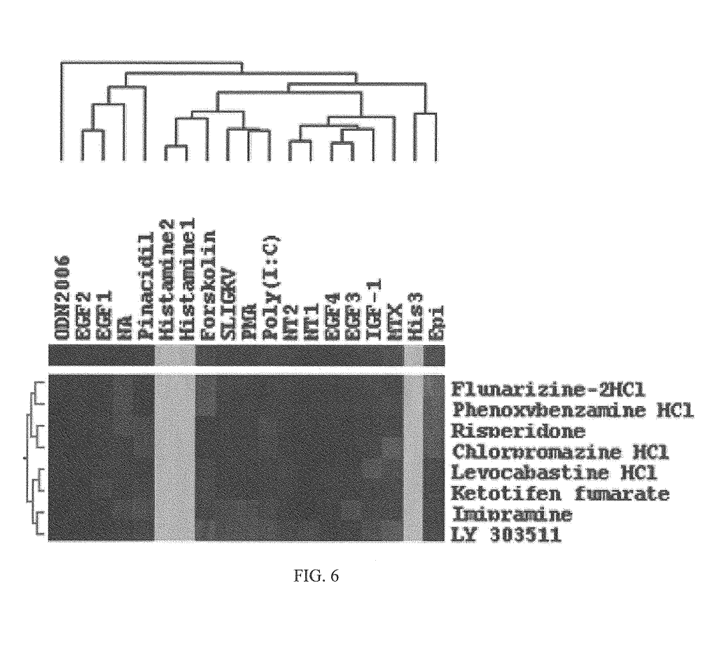

As shown in FIGS. 2 and 3, these known GPCR agonists were shown to trigger significant DMR signals in A431 cells. Although these DMR signals differ greatly in the shape, kinetics and amplitude, they can be viewed as a few of types. Pattern recognition and pattern matching can be used to visualize their relations. However, when the numbers of molecule biosensor primary profiles increase dramatically, it becomes more difficult to use conventional pattern recognition methods, such as supervised learning, to study the relations of the molecule primary indices. Clustering analysis has been widely and successfully used in gene expression and protein network analysis which often deals with large datasets. Thus, clustering analysis and its parameters were identified herein to categorize the molecule primary indices. Both Hierarchical and k-Means clustering methods were examined. Results showed that for the molecule primary indices, the Hierarchical clustering led to the more effective identification of types of DMR signals at different levels. Euclidean distance was a metric which worked best in label free biosensor methods to separate different clusters. The uncentered and absolute value method was found to be well-suited for building the linkages between clusters obtained using the molecule biosensor primary indices. The Heat map using Eisen TreeView was found to be effective to visualize the cluster analysis results. FIG. 4 showed the heat map of the known GPCR agonist-induced DMR signals in A431 cells. Here a max-min of 40 picometer was used as a cutoff to filter the original data. This heat map was generated using the real responses of each GPCR agonist at a 1-min time interval post stimulation. The two dimensional Hierarchical clustering with Euclideam distance showed that these known GPCR agonist-induced DMR signals can be classified into two categories at the lowest resolution, but they classified into 4 categories at the intermediate resolution, each category consists of many sub-clusters. The known Gₛ-coupled β2-adrerengic receptor (β2AR) agonists epinephrine, dopamine and phenylephrine trigged a DMR signal that is similar to forskolin. Similarly, the Gs-coupled adenosine A2B receptor agonist adenosine, IB-MECA, CCPA and CGS21680 also led to DMR signals that belong to the same cluster. On the other hand, the Gq-coupled P2Y2 receptor agonists, ATP and UTP, triggered DMR signals that belong to the same cluster. This cluster also contains the Gq-coupled bradykinin B2 receptor agonist bradykinin and the Gq-coupled S1P2 and S1P5 receptors agonist sphinosine-1-phosphate, as well as the protease activated receptor PAR1 agonist SFLLR and the PAR agonist SLIGKV. All of these receptors were endogenously expressed in A431 cells, as confirmed by quantitative RT-PCR (data not shown). Furthermore, the two-dimensional cluster analysis showed that the real responses at different time points are also interconnected and generally fall into two categories: the early response (<12 min post simulation) and the late response (>12 minutes). Further examination of the relation among these time points led to four sub clusters of time points (1-6 min, 7-12 min, 13-18 min, 19-50 min post stimulation), suggesting that it may be sufficient to effectively cluster the GPCR agonist primary DMR profiles in A431 cells using the real response at four time points, each within one period. FIG. 5 showed the heat map of the same set of GPCR agonist primary DMR signals in A431 cells using the real responses at four pre-selected time points post stimulation (3 min, 10 min, 20 min and 50 min, respectively). Here the max-min difference of 40 picometer was also used to filter the original data. Results showed that although there are differences in linkage, such 4 time points-based cluster analysis correctly categorized almost all GPCR agonists.

### 4. Example 4

### Identification of Anti-Histamine Molecules from a Library Based on the Biosensor Modulation Indices

To further explore the potential of cluster analysis for label-free integrative pharmacology, a library of ˜2000 compounds were subject to label-free integrative pharmacology analysis against a 15 marker/4 cell line panel. The cell/marker panel consists of the A549 cell (the mitochondria KATP opener pinacidil, the TLR3 agonist poly(I:C), the protein kinase C activator PMA, the adenylate cyclase activator forskolin, the PAR2 agonist SLIGKV, and the histamine H1 receptor agonist histamine), A431 cells (the β2AR agonist epinephrine, the EGFR agonist EGF, the GPR109A agonist nicotinic acid, and the histamine H1 receptor agonist histamine), HT29 cells (the EGFR/HER2 agonist EGF, the neurotensin receptor NTS1/NTS3 agonist neurotensin, the IGF1 receptor IGF1, and the hERG activator mallotoxin), and the HepG2 cell (the TL9 agonist ODN2006). All molecules in the library were screened in four cell lines to produce a library of biosensor primary indices. In addition, all molecules in the library were also screened in the four cell lines against each respective marker at EC100 to produce a library of biosensor modulation indices. The modulation indices were generated by normalizing the marker DMR signal in the presence of a molecule to the marker DMR in the absence of a molecule. For each marker, one or two specific DMR events were used for normalization. For A549 cells, it is pinacidil (the N-DMR at 30 min; pinacidil), Poly(I:C) (the P-DMR at 50 min, poly(I:C)), PMA (the P-DMR at 50 min, PMA), SLIGKV (the P-DMR at 20 min, SLIGKV), forskolin (the P-DMR at 50 min, Forskolin), Histamine (the P-DMR at 10 min, His1; the P-DMR at 30 min, His2) (the bolded name was indicated in FIG. 6, the same is for the below). For A431 cells, it is epinephrine (the P-DMR at 50 min, Epi), nicotinic acid (the N-DMR at 3 min, NA), EGF (the P-DMR at 5 min, EGF1; the N-DMR at 40 min, EGF2), and histamine (the P-DMR at 3 min, His3). For HT29 cells, it is EGF (the P-DMR at 8 min, EGF3; the P-DMR at 50 min, EGF4), IGF-1 (the P-DMR at 50 min, IGF1), mallotoxin (the P-DMR at 50 min, MTX), and neurotensin (the P-DMR at 5 min, NT1; and the P-DMR at 50 min, NT2). For HepG2 cells, it is ODN2006 (the N-DMR at 50 min, ODN2006).

As shown in the heat map generated using Eisen TreeView (FIG. 6), cluster analysis, using the Hierarchical Euclidean method, identified a specific node cluster that consists of 8 compounds, including the three known anti-histamines levocabastine, flunarizine, and ketotifen. The known alpha blocker phenoxybenzamine was also found to be similar to these antihistamines. Literature mining confirmed that phenoxybenzamine also blocks histamine (H1), acetylcholine, and serotonin receptors. Chlorpromazine is also known to be an antagonist on different postsynaptic receptors, including dopamine receptors (subtypes D1, D2, D3 and D4), serotonin receptors (5-HT1 and 5-HT2), histamine receptors (H1 receptor), α1- and α2-adrenergic receptors, and M1 and M2 muscarinic acetylcholine receptors. The antidepressant agent imipramine is also known to be an antagonist at histamine H1 receptors. The antipsychotic drug risperidone is known to antagonizes serotonin2 and dopamine-2 receptors in the central nervous system, and bind to alpha1- and alpha2-adrenergic receptors and histamine H1 receptors. These results suggest that the label-free integrative pharmacology approach provides for the identification of the hidden phenotype of known drugs and molecules, and allows the investigation of the polypharmacology of drugs and molecules. The similarity of LY303511 with those antihistamines indicates that this compound can also be a histamine H1R or a H1R pathway antagonist, indicating that label-free integrative pharmacology can identify molecules for a given target.

### 5. Example 5

### Cluster Analysis for Functional Selectivity of GPCR Ligands Acting on a Receptor

The quest to fully characterize the pharmacological activity of drug molecules with a wide spectrum of point-of-contact and phenotypic assays has led to the discovery of new pathway biased activity of many ligands for increasing numbers of GPCRs. A classical example is the beta blocker propranolol. Propranolol was recently identified as an inverse agonist for a Gs pathway, and also a β-arrestin dependent extracellular signal regulated kinase (ERK) agonist. These pathway-biased activities may contribute to the complex therapeutic profiles of drug molecules.

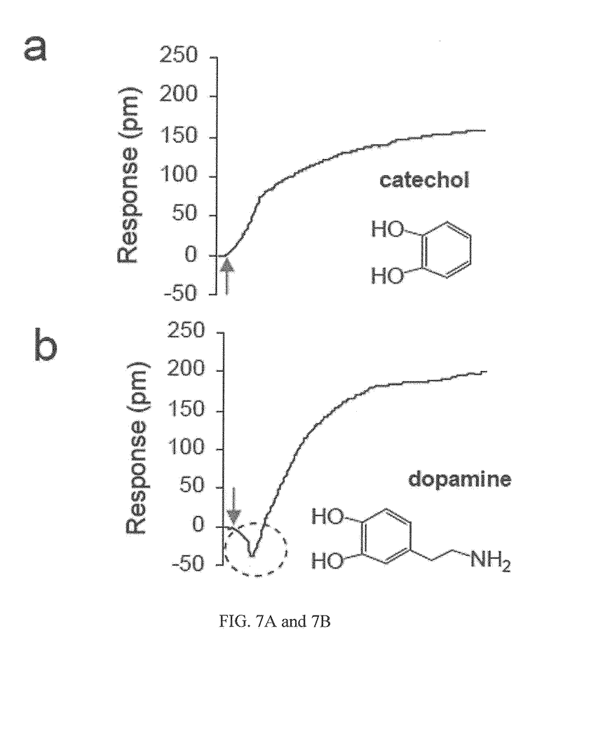

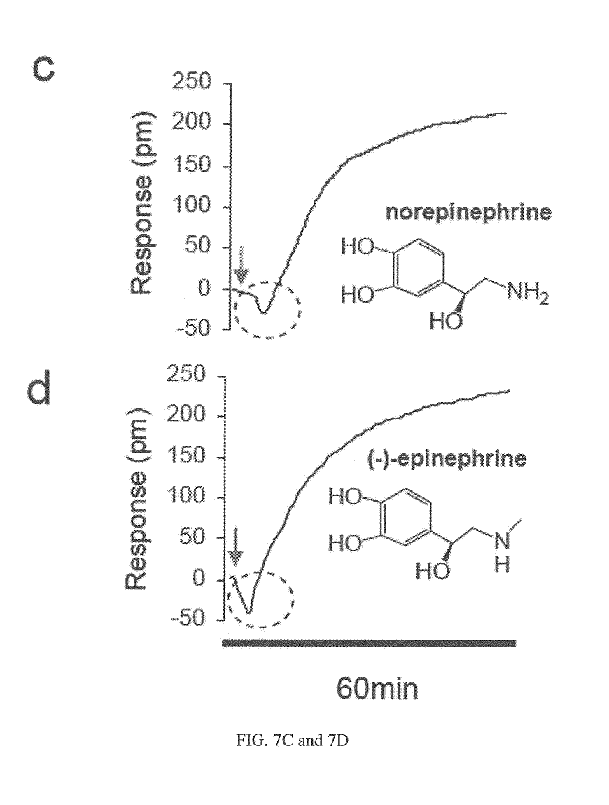

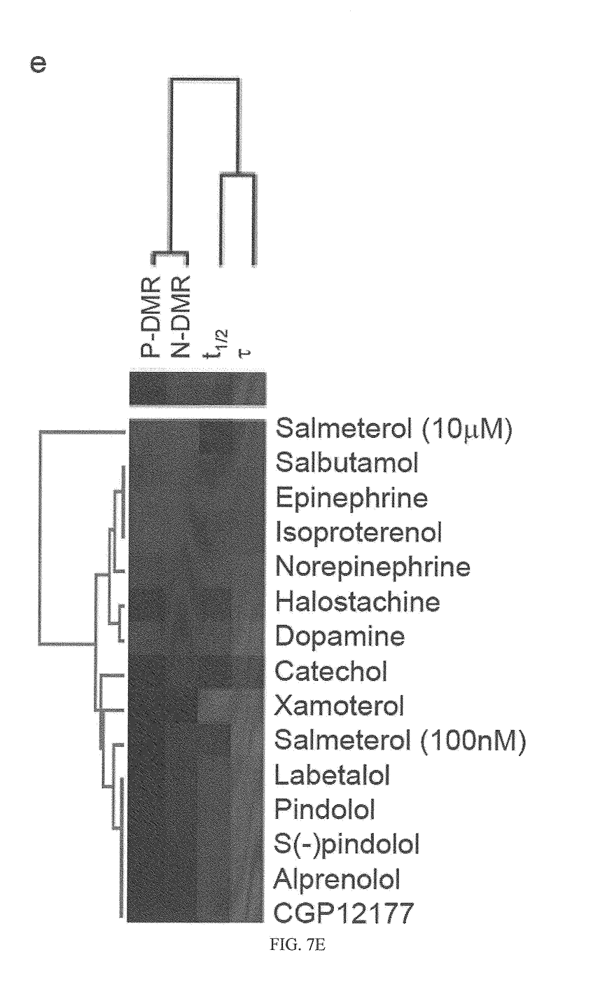

Label-free receptor assays allow a greater array of changes in the receptor to be detected. Using the DMR assays, a panel of β2-AR ligands was characterized in quiescent A431 cells (Fang, Y., and Ferrie, A. M. FEBS Lett. 2008, 582, 558-564). Multi-parameter analysis revealed unique patterns in the characteristics of their corresponding DMR signals (exampled in FIG. 7). Full agonists such as epinephrine and isoproterenol gave rise to a DMR with maximum amplitudes, fast transition time but slow kinetics for the P-DMR event. In comparison, partial agonists such as catechol and halostachine led to a DMR signal with smaller amplitudes, slightly slower transition time but faster kinetics for the P-DMR event. Similarity analysis indicates that these parameters can be used to categorize the agonism activity of these molecules. FIG. 7 shows representative DMR signals and structures of a panel of β2-AR agonists: (a) catechol of 500 μM; (b) dopamine of 32 μM; (c) norepinephrine of 100 nM; and (d) (−)epinephrine of 8 nM; each at the saturating concentration; (e) The heat map classification of β2-AR agonist pharmacology based on the characteristics of their corresponding DMR signals. The heat map was generated using the Euclidean hierarchical cluster analysis, after all DMR parameters were normalized to the epinephrine response. Data suggests that the first subgroup consists of full agonists and strong partial agonists including isoproterenol, epinephrine, norepinephrine, and salbutamol, while the second group consists of partial agonists including halostachine and dopamine. The third group consists of the beta-blockers with weak partial agonism activity, including labetalol, pindolol, S(−)pindolol, alprenolol, CGP12177, and to certain extent, salmeterol of 100 nM. The weak agonist catechol and the partial agonist xamoterol are between the second and third group. Salmeterol of 10 μM leads to very unique DMR that is similar but not identical to the full agonists.

### F. References

1. WO2006108183. Fang, Y., Ferrie, A. M., Fontaine, N. M., Yuen, P. K. and Lahiri, J. “Optical biosensors and cells”
2. U.S. application Ser. No. 12/623,693. Fang, Y., Ferrie, A. M., Lahiri, J., and Tran, E. “Methods for Characterizing Molecules”, Filed Nov. 23, 2009
3. U.S. application Ser. No. 12/623,708. Fang, Y., Ferrie, A. M., Lahiri, J., and Tran, E. “Methods of creating an index”, filed Nov. 23, 2009.
4. M. B. Eisen, P. T. Spellman, P. O. Brown, and David Botstein: Cluster analysis and display of genome-wide expression patterns. PNAS, 95(25):14863-8 (1998)

We claim:

1. A method of determining the similarity of a label-free biosensor data set comprising: a) obtaining a label free biosensor data set, b) performing a cluster analysis on said data set.

2. The method of claim 1, wherein the cluster analysis comprises performing a Hierarchical clustering method.

3. The method of claim 2, wherein the Hierarchical clustering method comprises an agglomerative method.

4. The method of claim 2, wherein the Hierarchical clustering method comprises a divisive method.

5. The method of claim 4, wherein the distance metric comprise a Euclidean distance method, squared Euclidean distance method, City-block distance method, Manhattan distance method, Pearson corrlation method, Pearson corrlation absolute value method, Uncentered correlation method, Centered correlation method, Spearman's rank correlation method, Kendall's tau method, maximum distance method, Mahalanobis distance method, or a cosine similarity method.

6. The method of claim 5, wherein when the data set comprises data from a primary indice the distance metric comprises the uncentered correlation with absolute value.

7. The method of claim 6, wherein when the data set comprises data from a molecule modulation indice the distance metric comprises either the uncentered correlation with absolute value method or the centered correlation with absolute value method.

8. The method of claim 1, further comprising a distance matrix.

9. The method of claim 8, further comprising a predefined clustering threshold, wherein the predefined clustering threshold is a biosensor parameter.

10. The method of claim 9, further comprising a normalization or data pretreatment step.

11. The method of claim 10, wherein the clustering analysis comprises a two-dimensional clustering analysis.

12. The method of claim 11, further comprising the step of producing a heat map.

13. The method of claim 12, wherein the method is a computer implemented method.

14. The method of claim 13, further comprising the step of outputting results from the cluster analysis.

15. A method of analyzing a label free biosensor data set comprising; receiving a label free biosensor data set record and performing a cluster analysis, wherein the record contains biosensor data measuring a biosensor response and outputting results from the cluster analysis, wherein the method is a computer implemented method.

16. The method of claim 15, wherein receiving the label free biosensor data set record comprises receiving the label free biosensor data set record from a storage medium, wherein receiving the label free biosensor data set record comprises receiving the record from a computer system, wherein receiving the label free biosensor data set record comprises receiving the record from a biosensor system, wherein receiving the label free biosensor data set record comprises receiving the label free biosensor data set record via a computer network.

17. One or more computer readable media storing program code that, upon execution by one or more computer systems, causes the computer systems to perform the method of claim 15.

18. A computer program product comprising a computer usable memory adapted to be executed to implement the method of claim 15, wherein the computer program comprises a logic processing module, a configuration file processing module, a data organization module, and data display organization module, that are embodied upon a computer readable medium.

19. A computer program product, comprising a computer usable medium having a computer readable program code embodied therein, said computer readable program code adapted to be executed to implement a method for generating the cluster analysis of claim 15, said method further comprising: providing a system, wherein the system comprises distinct software modules, and wherein the distinct software modules comprise a logic processing module, a configuration file processing module, a data organization module, and a data display organization module.

20. A cluster analysis system, the system comprising: a data store capable of storing label free biosensor data set; a system processor comprising one or more processing elements, the one or more processing elements programmed or adapted to: receive the label free biosensor data set; store the label free biosensor data set in the data store; perform a cluster analysis on the label free biosensor data set; and output a result from the cluster analysis.
